(19) United States
(12) Patent Application Publication
(10) Pub. No.: US 2025/0097076 A1
(43) Pub. Date: Mar. 20, 2025

(54) TECHNIQUES FOR REPORTING SUB-BAND FULL-DUPLEX (SBFD) CAPABILITY UPDATES

(71) Applicant: QUALCOMM Incorporated, San Diego, CA (US)

(72) Inventors: Ahmed Attia ABOTABL, San Diego, CA (US); Abdelrahman Mohamed Ahmed Mohamed IBRAHIM, San Diego, CA (US); Muhammad Sayed Khairy ABDELGHAFFAR, San Jose, CA (US)

(21) Appl. No.: 18/468,237

(22) Filed: Sep. 15, 2023

(51) Int. Cl. H04L 25/02; H04L 5/14

(52) U.S. Cl. CPC H04L 25/0212; H04L 5/14

(57) ABSTRACT

Methods, systems, and devices for wireless communication are described. A user equipment (UE) may communicate a signal using a first duplexing mode in accordance with a sub-band full-duplex (SBFD) capability of the UE. The UE may perform one or more measurements on the signal to obtain a channel impulse response (CIR) associated with communication of the signal. The UE may transmit a message that includes information indicative of an update pertaining to the SBFD capability of the UE. The update may be based on the channel impulse response and may identify a second duplexing mode for wireless communication by the UE.

### FIELD OF TECHNOLOGY

The following relates to wireless communication, including techniques for reporting sub-band full-duplex (SBFD) capability updates.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more network entities, each supporting wireless communication for communication devices, which may be known as user equipment (UE).

### SUMMARY

The described techniques relate to improved methods, systems, devices, and apparatuses that support techniques for reporting sub-band full-duplex (SBFD) capability updates. For example, the described techniques provide a framework indicating an update pertaining to SBFD capabilities of the UE. In some examples, the UE may communicate (transmit or receive) a signal using a first duplexing mode in accordance with an SBFD capability of the UE. The UE may perform one or more measurements on the signal to obtain a channel impulse response (CIR) associated with communication of the signal. In some examples, the UE may transmit a message that includes information indicative of an update pertaining to the SBFD capability of the UE. The update may be based on the CIR and may identify a second duplexing mode for wireless communication by the UE.

A method for wireless communication by a UE is described. The method may include communicating a signal using a first duplexing mode in accordance with an SBFD capability of the UE, performing one or more measurements on the signal to obtain a CIR associated with communicating the signal, and transmitting a message including information indicative of an update pertaining to the SBFD capability of the UE, where the update is based on the CIR and identifies a second duplexing mode for wireless communication by the UE.

A UE for wireless communication is described. The UE may include one or more memories storing processor executable code, and one or more processors coupled with the one or more memories. The one or more processors may individually or collectively operable to execute the code to cause the UE to communicate a signal using a first duplexing mode in accordance with an SBFD capability of the UE, perform one or more measurements on the signal to obtain a CIR associated with communicating the signal, and transmit a message including information indicative of an update pertaining to the SBFD capability of the UE, where the update is based on the CIR and identifies a second duplexing mode for wireless communication by the UE.

Another UE for wireless communication is described. The UE may include means for communicating a signal using a first duplexing mode in accordance with an SBFD capability of the UE, means for performing one or more measurements on the signal to obtain a CIR associated with communicating the signal, and means for transmitting a message including information indicative of an update pertaining to the SBFD capability of the UE, where the update is based on the CIR and identifies a second duplexing mode for wireless communication by the UE.

A non-transitory computer-readable medium storing code for wireless communication is described. The code may include instructions executable by a processor to communicate a signal using a first duplexing mode in accordance with an SBFD capability of the UE, perform one or more measurements on the signal to obtain a CIR associated with communicating the signal, and transmit a message including information indicative of an update pertaining to the SBFD capability of the UE, where the update is based on the CIR and identifies a second duplexing mode for wireless communication by the UE.

Some examples of the method, UEs, and non-transitory computer-readable medium described herein may further include operations, features, means, or instructions for transmitting a first message at a first time, the first message including first information that may be indicative of the SBFD capability of the UE and that identifies the first duplexing mode for wireless communication by the UE, where the message may be transmitted at a second time subsequent to the first time, and where the update may be relative to the first information.

In some examples of the method, UEs, and non-transitory computer-readable medium described herein, the update includes that the SBFD capability may be maintained at the UE over a duration between the first time and the second time and the second duplexing mode may be the same as the first duplexing mode based on the SBFD capability being maintained.

In some examples of the method, UEs, and non-transitory computer-readable medium described herein, the update includes that the SBFD capability may be not maintained at the UE over a duration between the first time and the second time and the second duplexing mode may be different than the first duplexing mode based on the SBFD capability not being maintained.

In some examples of the method, UEs, and non-transitory computer-readable medium described herein, the message may be transmitted to a network entity and the update indicates an expectation that the UE may be operating in accordance with the second duplexing mode and the network entity may be operating in accordance with the first duplexing mode.

In some examples of the method, UEs, and non-transitory computer-readable medium described herein, the information may be indicative of a modification to the SBFD capability of the UE, and the second duplexing mode may be based on the modification.

In some examples of the method, UEs, and non-transitory computer-readable medium described herein, the modification may be associated with at least one of a spatial domain parameter, a power domain parameter, or a frequency domain parameter usable at the UE for wireless communications in accordance with one or more duplexing modes.

In some examples of the method, UEs, and non-transitory computer-readable medium described herein, the modification may be based on the CIR satisfying a threshold.

In some examples of the method, UEs, and non-transitory computer-readable medium described herein, the information includes at least one bit corresponding to the update.

Some examples of the method, UEs, and non-transitory computer-readable medium described herein may further include operations, features, means, or instructions for receiving a second message including second information indicative of a mapping between the at least one bit and the update, where the information including the at least one bit may be in accordance with the mapping.

In some examples of the method, UEs, and non-transitory computer-readable medium described herein, the second information may be indicative of a set of multiple mappings between a set of multiple bits and a set of multiple updates, and the set of multiple mappings includes at least the mapping.

Some examples of the method, UEs, and non-transitory computer-readable medium described herein may further include operations, features, means, or instructions for transmitting the message may be based on an expiration of a timer.

Some examples of the method, UEs, and non-transitory computer-readable medium described herein may further include operations, features, means, or instructions for transmitting a first message including first information that may be indicative of the SBFD capability of the UE and that identifies the first duplexing mode for wireless communication by the UE and initiating the timer in response to transmitting the first message.

Some examples of the method, UEs, and non-transitory computer-readable medium described herein may further include operations, features, means, or instructions for identifying a modification to the SBFD capability of the UE based on the CIR and initiating the timer in response to identifying the modification, where transmitting the message may be based on the modification being maintained at the UE over a duration of the timer.

Some examples of the method, UEs, and non-transitory computer-readable medium described herein may further include operations, features, means, or instructions for receiving an indication of a quantity of transmission time intervals (TTIs), where the timer may be based on the quantity of TTIs.

Some examples of the method, UEs, and non-transitory computer-readable medium described herein may further include operations, features, means, or instructions for receiving an indication of a periodicity associated with reporting updates pertaining to the SBFD capability of the UE, where transmitting the message may be in accordance with the periodicity.

In some examples of the method, UEs, and non-transitory computer-readable medium described herein, the information includes an indication of the second duplexing mode.

In some examples of the method, UEs, and non-transitory computer-readable medium described herein, the information includes uplink control information (UCI) or a medium access control-control element (MAC-CE).

A method for wireless communication by a network entity is described. The method may include communicating a signal between the network entity and a UE in accordance with a first duplexing mode that is based on an SBFD capability of the UE and obtaining a message including information indicative of an update pertaining to the SBFD capability of the UE, where the update is based on a CIR associated with communicating the signal, and where the update identifies a second duplexing mode for wireless communication by the UE.

A network entity for wireless communication is described. The network entity may include one or more memories storing processor executable code, and one or more processors coupled with the one or more memories. The one or more processors may individually or collectively operable to execute the code to cause the network entity to communicate a signal between the network entity and a UE in accordance with a first duplexing mode that is based on an SBFD capability of the UE and obtain a message including information indicative of an update pertaining to the SBFD capability of the UE, where the update is based on a CIR associated with communicating the signal, and where the update identifies a second duplexing mode for wireless communication by the UE.

Another network entity for wireless communication is described. The network entity may include means for communicating a signal between the network entity and a UE in accordance with a first duplexing mode that is based on an SBFD capability of the UE and means for obtaining a message including information indicative of an update pertaining to the SBFD capability of the UE, where the update is based on a CIR associated with communicating the signal, and where the update identifies a second duplexing mode for wireless communication by the UE.

A non-transitory computer-readable medium storing code for wireless communication is described. The code may include instructions executable by a processor to communicate a signal between the network entity and a UE in accordance with a first duplexing mode that is based on an SBFD capability of the UE and obtain a message including information indicative of an update pertaining to the SBFD capability of the UE, where the update is based on a CIR associated with communicating the signal, and where the update identifies a second duplexing mode for wireless communication by the UE.

Some examples of the method, network entities, and non-transitory computer-readable medium described herein may further include operations, features, means, or instructions for obtaining a first message at a first time, the first message including first information that may be indicative of the SBFD capability of the UE and that identifies the first duplexing mode for wireless communication by the UE, where the message may be obtained at a second time subsequent to the first time, and where the update may be relative to the first information.

In some examples of the method, network entities, and non-transitory computer-readable medium described herein, the update includes that the SBFD capability may be maintained at the UE over a duration between the first time and the second time and the second duplexing mode may be the same as the first duplexing mode based on the SBFD capability being maintained.

In some examples of the method, network entities, and non-transitory computer-readable medium described herein, the update includes that the SBFD capability may be not maintained at the UE over a duration between the first time and the second time and the second duplexing mode may be different than the first duplexing mode based on the SBFD capability not being maintained.

In some examples of the method, network entities, and non-transitory computer-readable medium described herein, the update indicates an expectation that the UE may be operating in accordance with the second duplexing mode and the network entity may be operating in accordance with the first duplexing mode.

In some examples of the method, network entities, and non-transitory computer-readable medium described herein, the information may be indicative of a modification to the SBFD capability of the UE, and the second duplexing mode may be based on the modification.

In some examples of the method, network entities, and non-transitory computer-readable medium described herein, the modification may be associated with at least one of a spatial domain parameter, a power domain parameter, or a frequency domain parameter usable at the UE for wireless communications in accordance with one or more duplexing modes.

In some examples of the method, network entities, and non-transitory computer-readable medium described herein, the modification may be based on the CIR satisfying a threshold.

In some examples of the method, network entities, and non-transitory computer-readable medium described herein, the information includes at least one bit corresponding to the update.

Some examples of the method, network entities, and non-transitory computer-readable medium described herein may further include operations, features, means, or instructions for outputting a second message including second information indicative of a mapping between the at least one bit and the update, where the information including the at least one bit may be in accordance with the mapping.

In some examples of the method, network entities, and non-transitory computer-readable medium described herein, the second information may be indicative of a set of multiple mappings between a set of multiple bits and a set of multiple updates and the set of multiple mappings includes at least the mapping.

Some examples of the method, network entities, and non-transitory computer-readable medium described herein may further include operations, features, means, or instructions for obtaining the message may be based on an expiration of a timer.

Some examples of the method, network entities, and non-transitory computer-readable medium described herein may further include operations, features, means, or instructions for obtaining a first message including first information that may be indicative of the SBFD capability of the UE and that identifies the first duplexing mode for wireless communication by the UE and initiating the timer in response to obtaining the first message.

Some examples of the method, network entities, and non-transitory computer-readable medium described herein may further include operations, features, means, or instructions for outputting an indication of a quantity of TTIs, where the timer may be based on the quantity of TTIs.

Some examples of the method, network entities, and non-transitory computer-readable medium described herein may further include operations, features, means, or instructions for outputting an indication of a periodicity associated with reporting updates pertaining to the SBFD capability of the UE, where obtaining the message may be in accordance with the periodicity.

In some examples of the method, network entities, and non-transitory computer-readable medium described herein, the information includes an indication of the second duplexing mode.

In some examples of the method, network entities, and non-transitory computer-readable medium described herein, the information includes UCI or a MAC-CE.

### BRIEF DESCRIPTION OF THE DRAWINGS

FIGS. 1, 2, and 3 each show an example of a wireless communications system that supports techniques for reporting sub-band full-duplex (SBFD) capability updates in accordance with one or more aspects of the present disclosure.

FIGS. 4A and 4B each show examples of a transmission time interval (TTI) configuration that supports techniques for reporting SBFD capability updates in accordance with one or more aspects of the present disclosure.

FIGS. 5A and 5B each show an example of a timing diagram that supports techniques for reporting SBFD capability updates in accordance with one or more aspects of the present disclosure.

FIG. 6 shows an example of a process flow that supports techniques for reporting SBFD capability updates in accordance with one or more aspects of the present disclosure.

FIGS. 7 and 8 show block diagrams of devices that support techniques for reporting SBFD capability updates in accordance with one or more aspects of the present disclosure.

FIG. 9 shows a block diagram of a communications manager that supports techniques for reporting SBFD capability updates in accordance with one or more aspects of the present disclosure.

FIG. 10 shows a diagram of a system including a device that supports techniques for reporting SBFD capability updates in accordance with one or more aspects of the present disclosure.

FIGS. 11 and 12 show block diagrams of devices that support techniques for reporting SBFD capability updates in accordance with one or more aspects of the present disclosure.

FIG. 13 shows a block diagram of a communications manager that supports techniques for reporting SBFD capability updates in accordance with one or more aspects of the present disclosure.

FIG. 14 shows a diagram of a system including a device that supports techniques for reporting SBFD capability updates in accordance with one or more aspects of the present disclosure.

FIGS. 15 and 16 show flowcharts illustrating methods that support techniques for reporting SBFD capability updates in accordance with one or more aspects of the present disclosure.

### DETAILED DESCRIPTION

A wireless communications system may support one or more types of duplex operations. For example, the wireless communications system may support half-duplex operations in which a communication device may either transmit or receive over a time domain resource (e.g., may not simultaneously transmit and receive), and full-duplex operations in which the communication device may simultaneously transmit and receive over the time domain resource (e.g., may simultaneously transmit and receive). In some examples of full-duplex communications, the communication device may be configured to operate in a full-duplex mode in which the communication device may transmit and receive on the same time domain resource, but on different frequency resources. For example, the communication device may be configured with an uplink sub-band (for uplink communications) that may be non-overlapping with one or more downlink sub-bands (for downlink communications). Such full-duplex communications may be referred to as sub-band full-duplex (SBFD) communications.

The communication device (e.g., a user equipment (UE)) may be configured to support SBFD communications in which the UE may transmit a signal to a network entity via the uplink sub-band, while simultaneously receiving another signal from the network entity via one or more of the downlink sub-bands. The received signal may be susceptible to self-interference (at the UE) due, in part, to reflections of the transmitted signal off various objects in the environment of the UE. Such reflections may be referred to as clutter reflections. A capability of the UE to support SBFD communications may be based on a capability of the UE to mitigate (e.g., effectively mitigate) the self-interference. The UE may be configured to support various interference cancellation techniques, such as linear interference cancellation (LIC) techniques and non-linear interference cancellation (NLIC) techniques. In some examples, however, such techniques may be constrained (e.g., by hardware and software at the UE) to cancel interference up to a threshold. Consequently, the UE may be unable to support SBFD communications in scenarios in which a level of self-interference at the UE (e.g., due to clutter reflections) exceeds the threshold. The level of self-interference at the UE due to clutter reflections may vary based on the environment of the UE and, therefore, the capability of the UE to support SBFD communications may also vary based on the environment of the UE. That is, the capability of the UE to support SBFD may change over time (e.g., based on changes in the environment of the UE). The UE may lack a mechanism, much less an effective mechanism, for indicating changes in the SBFD capability of the UE to the network entity. In other words, the UE may lack a mechanism for updating the network entity on whether the UE is capable of supporting SBFD communications, which may lead to scheduling conflicts at the network entity and reduce a reliability of communication between the UE and the network entity.

Various aspects of the present disclosure generally relate to techniques for reporting SBFD capability updates and, more specifically, to a framework for indicating an update pertaining to SBFD capabilities of the UE. For example, in accordance with such techniques, the UE may use sensing or channel estimation to obtain a profile of the clutter reflections (also referred to herein as a channel impulse response (CIR)), which may be representative of the level of self-interference experienced at the UE. The UE may use the clutter profile to determine whether the UE is capable of supporting SBFD communications. That is, the UE may determine whether the SBFD capability of the UE is maintained (or may be maintained) based on the level of self-interference experienced at the UE (e.g., as indicated via the clutter profile). The UE may transmit a message that includes information indicative of an update pertaining to the SBFD capability of the UE. The update may be based on the clutter profile and may identify a duplexing mode for wireless communication by the UE. In other words, the UE may transmit information to the network entity that updates the network on whether the SBFD capability of the UE is maintained.

In some examples, the update may include information that indicates that the SBFD capability of the UE is maintained (e.g., has not changed over a duration or relative to a previous or initial indication) or indicates that the SBFD capability is not maintained (e.g., has changed over a duration or relative to a previous or initial indication). In some examples, the SBFD capability of the UE may be maintained and, as such, the update may indicate a full-duplex mode (e.g., an SBFD mode) for wireless communications by the UE. In some other examples, the SBFD capability of the UE may not be maintained and, as such, the update may indicate a half-duplex mode (or a reduced SBFD mode) for wireless communications by the UE. The information may be transmitted from the UE in the form of UE assistance information or UE capability information.

In some other examples, the update could include information that indicates a modification to the full-duplex capability of the UE. For example, the UE may be capable of supporting SBFD communications with modified conditions, such as with a particular guard band (e.g., an additional guard band) or with a reduced transmit power. As such, the UE may transmit the information to indicate, to the network entity, the modification to the SBFD capability. For example, the information may include one or more bits (e.g., a bitmap) that corresponds to a quantity of resource blocks (RBs) to be used for a guard band between the uplink sub-band and the one or more downlink sub-bands. The UE may transmit the update periodically (e.g., in accordance with a periodicity) or based on a timer.

Aspects of the disclosure are initially described in the context of wireless communications systems. Aspects of the disclosure are also described in the context of transmission time interval (TTI) configurations, timing diagrams, and a process flow. Aspects of the disclosure are further illustrated by and described with reference to apparatus diagrams, system diagrams, and flowcharts that relate to techniques for reporting SBFD capability updates.

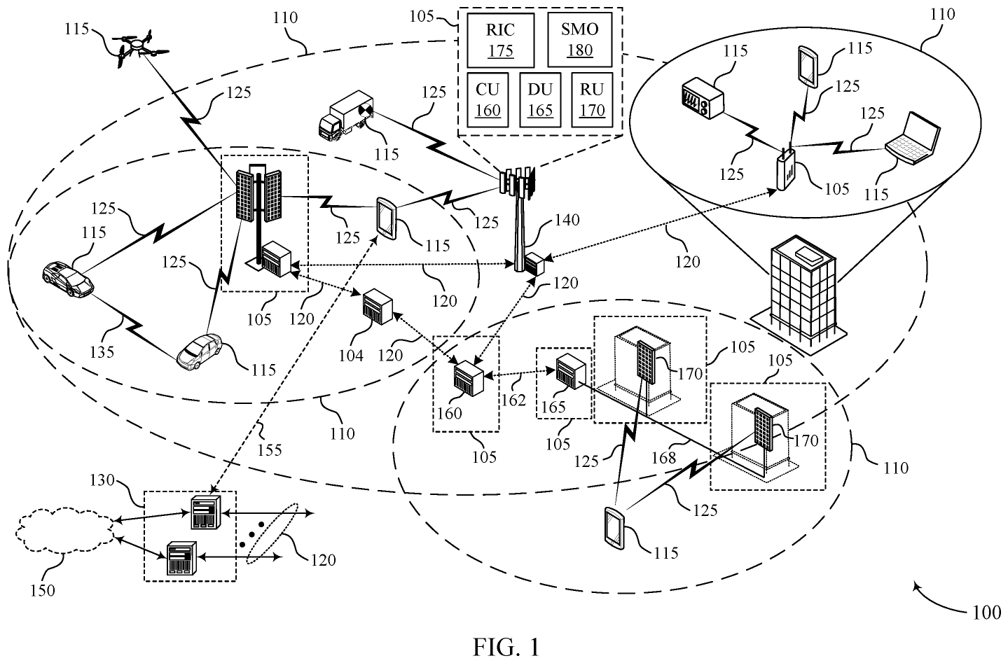

FIG. 1 shows an example of a wireless communications system 100 that supports techniques for reporting SBFD capability updates in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c. F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for reporting SBFD capability updates as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking. Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHZ.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

In some examples of the wireless communications system 100, a UE 115 may support one or more types of duplex operations, such as half-duplex operations and full-duplex operations (e.g., SBFD operations). For example, the UE 115 may be configured to support SBFD communications in which the UE 115 may transmit a signal to a network entity 105 via the uplink sub-band, while simultaneously receiving another signal from the network entity 105 via one or more of the downlink sub-bands. The received signal may be susceptible to self-interference due, in part, to clutter reflections of the transmitted signal off various objects in the environment of the UE 115. A capability of the UE 115 to support SBFD communications may be based on a capability of the UE 115 to mitigate (e.g., cancel) the self-interference. In some examples, however, such techniques may be constrained such that the UE 115 may cancel interference up to a threshold. Consequently, the UE 115 may be unable to support SBFD communications in scenarios in which a level of self-interference at the UE 115 satisfies (e.g., exceeds, is above) the threshold. The level of self-interference at the UE 115 due to clutter reflections may vary based on the environment of the UE 115 and, therefore, the capability of the UE 115 to support SBFD may change over time, for example, based on changes in the environment of the UE 115. In some examples, the UE 115 may lack a mechanism for indicating changes in the SBFD capability of the UE 115 to the network entity 105.

In some other examples, the UE 115 may support a framework for indicating an update pertaining to SBFD capabilities of the UE 115. In accordance with the framework, the UE 115 may use sensing or channel estimation to obtain a profile of the clutter reflections, which may be representative of a level of self-interference experienced at the UE 115. As such, the UE 115 may use the clutter profile to determine whether the UE 115 is capable of supporting SBFD communications. The UE 115 may transmit a message that includes information indicative of an update pertaining to the SBFD capability of the UE 115. The update may be based on the clutter profile and may indicate whether the SBFD capability of the UE 115 is maintained. In some examples, updating the network entity 105 on whether the SBFD capability of the UE 115 is maintained may reduce scheduling conflicts at the network entity 105 and increase a reliability of communication between the UE 115 and the network entity 105, among other benefits.

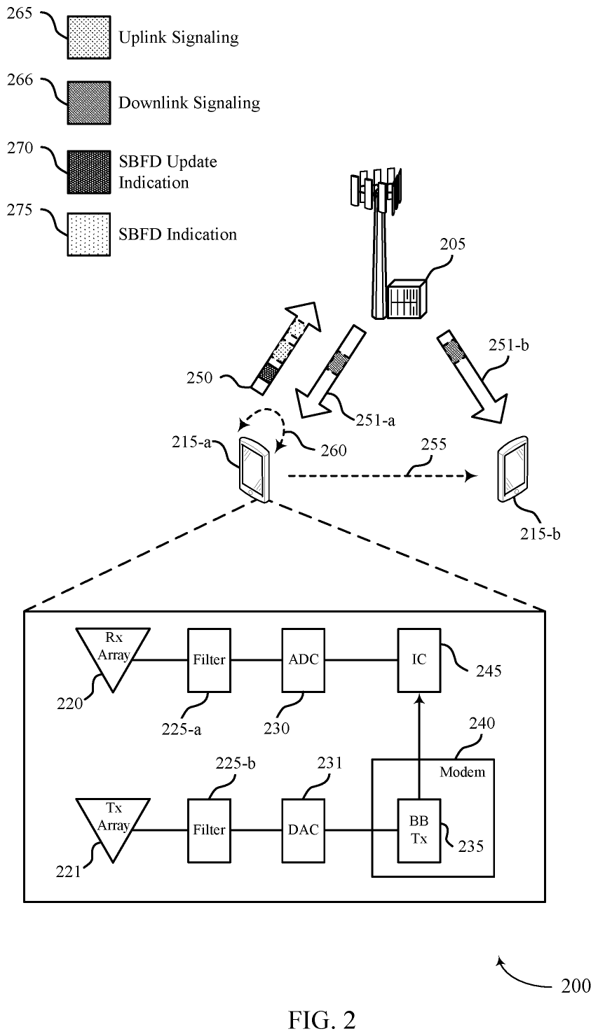

FIG. 2 shows an example of a wireless communications system 200 that supports techniques for reporting SBFD capability updates in accordance with one or more aspects of the present disclosure. The wireless communications system 200 may implement or be implemented at one or more aspects the wireless communications system 100. For example, the wireless communications system 200 may include a UE 215-a and a UE 215-b, which may be examples of a UE illustrated by and described with reference to FIG. 1. The wireless communications system 200 may also include a network entity 205, which may be examples of a network entity (e.g., a CU, a DU, an RU, a base station, an IAB node, or one or more other network nodes) illustrated by and described with reference to FIG. 1. The network entity 205 may transmit downlink communications to the UE 215-a and the UE 215-b via a downlink communication link 251-a and a downlink communication link 251-b, respectively. Additionally, the network entity 205 may receive uplink communications from the UE 215-a via an uplink communication link 250. The uplink communication link 250 and the downlink communication links 251 may be examples of a communication link (e.g., a Uu link, and access link) illustrated by and as described with reference to FIG. 1. The wireless communications system 200 may include features for improved communications between the network entity 205 and the UEs 215, among other benefits.

The wireless communications system 200 (e.g., an NR system) may support one or more types of duplex operations (e.g., half-duplex operations, full-duplex operations). In other words, the wireless communications system 200 may support one or more duplexing schemes for an air interface (e.g., an existing air interface, a new air interface). For example, the wireless communications system 200 may support one or more types of duplex operations for one or more deployment scenarios. The wireless communications system 200 may support a deployment scenario in which the network entity 205 supports SBFD and one or both of the UEs 215 are SBFD-aware. That is, the wireless communications system 200 may support an SBFD gNB and one or more enhancements for SBFD-aware UEs. As described herein, an SBFD-aware UE may refer to a UE that supports half-duplex operations (e.g., operates in a half-duplex manner) and may determine (e.g., understand, be aware) that a serving network entity supports SBFD operations (e.g., operates in an SBFD manner). That is, in some examples, the UEs 215 may be SBFD aware and, as such, the network entity 205 may expect that the UEs 215 are operating in accordance with a half-duplex mode and are aware that the network entity 205 is operating in accordance with a full-duplex mode.

In some examples, such as examples in which the network entity 205 supports SBFD, the network entity 205 may configure one or both of the UEs 215 with an SBFD configuration (e.g., via an indication and dynamic updates). Additionally, or alternatively, the network entity 205 may indicate, to one or both of the UEs 215 (e.g., to an SBFD-aware UE) a resource allocation for uplink or downlink signals and channels. In some examples, a network entity that supports SBFD operations (or one or more other full-duplex operations) may support one or more cross-link interference (CLI) or self-interference (SI) mitigation techniques. For example, the network entity 205 may support SBFD collision handling or SBFD-specific CLI enhancements, or both.

Additionally, or alternatively, the wireless communications system 200 may support a deployment scenario in which the network entity 205 and one or both of the UEs 215 support full-duplex. That is, the wireless communications system 200 may support one or more full-duplex UEs. Additionally, or alternatively, the wireless communications system 200 may support partially or fully overlapping sub-bands. That is, one or more sub-bands allocated for downlink and one or more sub-bands allocated for uplink may be partially or fully overlapping. In other words, the wireless communications system 200 may support a full-duplex-UE, partially overlapping sub-bands, or fully overlapping sub-bands, or some combination thereof. As described herein, a band (e.g., an operating band) may refer to a set of frequencies (e.g., a range of frequencies, a carrier) that may be used for both transmissions and receptions at a device (e.g., the network entity 205, the UE 215-a, the UE 215-b). Additionally, a sub-band may refer to a portion of a band that may be used for either transmissions or receptions at the device. For example, the device may be the UE 215-a and a sub-band may be used for uplink transmissions and another sub-band may be used for downlink receptions. In some examples, full-duplex with partially or fully overlapping sub-bands may be referred to herein as in-band full-duplex (IBFD). Additionally, or alternatively, the wireless communications system 200 may support non-overlapping sub-bands. That is, one or more sub-bands allocated for downlink may be non-overlapping in frequency with one or more sub-bands allocated for uplink. In some examples, full-duplex with non-overlapping sub-bands may be referred to herein as SBFD. That is, the wireless communications system 200 may support an SBFD UE and an SBFD gNB (simultaneously) and may also support IBFD. That is, the wireless communications system 200 may include an SBFD UE and an SBFD gNB, and may also support partially overlapping uplink and downlink sub-bands at the gNB.

In some examples, full-duplex operations may lead to one or more types of interference, such as CLI 255 and SI 260. As described herein, CLI may refer to interference experienced at a device (e.g., the UE 215-b) due to a reception at the device overlapping (e.g., in time) with a transmission at another device (e.g., a neighboring device, such as the UE 215-a). As illustrated in the example of FIG. 2, the UE 215-b may experience CLI 255 due to an uplink transmission at the UE 215-a (e.g., uplink signaling 265) overlapping in the time domain with a downlink reception at the UE 215-b (e.g., downlink signaling 266). Additionally, as described herein, SI may refer to interference experienced at a device (e.g., a device capable of supporting full-duplex operations, such as the network entity 205 or the UE 215-a) due to signal leakage between an antenna panel used at the device for transmissions and another antenna panel used at the device for receptions, or due to clutter reflections. As illustrated in the example of FIG. 2, the UE 215-a may experience the SI 260 due to signal leakage from a transmit array 221 (e.g., an array of antennas used for transmissions) to a receive array 220 (e.g., an array of antennas used for receptions). Additionally, or alternatively, the UE 215-a may experience the SI 260 due to clutter reflections (e.g., from one or more reflectors in an environment of the UE 215). As described herein, clutter reflections (also referred to as clutter or clutter interference) may refer to interference experience at a device due to a portion of a signal transmitted from the device being reflected back to the device via a reflector (e.g., a reflective surface). As such, clutter reflections may impact receptions at full-duplex devices (e.g., devices operating in a full-duplex mode, such as the network entity 205 or the UE 215-a). In other words, the SI 260 experienced at the UE 215-a may be due to both signal leakage (from the transmit array 221 to the receive array 220) and clutter reflections (from reflective objects in the environment of the UE 215-a).

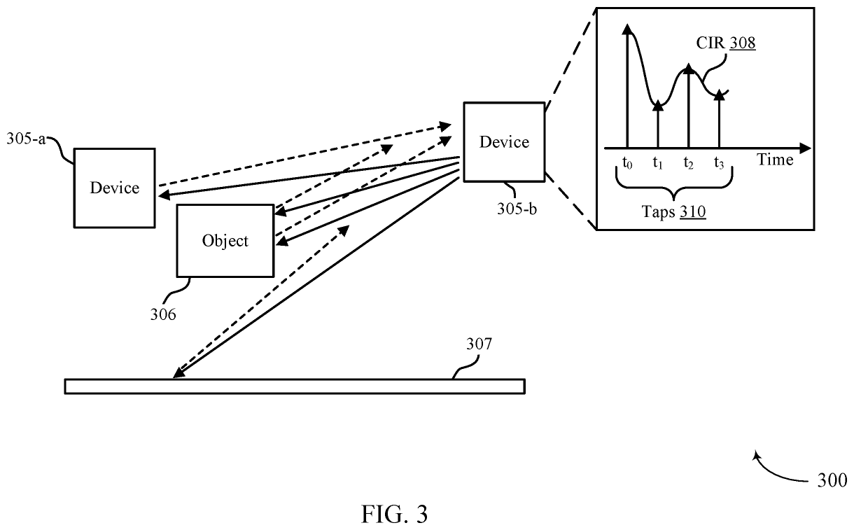

For example, the UE 215-a may transmit uplink signaling 265 to the network entity 205 via the transmit array 221 (e.g., via the transmit chain including the transmit array 221, filter 225-b, digital to analog converter (DAC) 231, and modem 240 including baseband transmitter 235), while simultaneously receiving downlink signaling 266 from the network entity 205 via the receive array 220 (e.g., via the receive chain including the receive array 220, filter 225-a, analog to digital converter (ADC) 230, and interference cancellation (IC) 245 including LIC and NLIC). In such an example, the UE 215-a may receive (e.g., detect) both the downlink signaling 266 from the network entity 205 and reflections (clutter reflections) of the uplink signaling 265 off reflectors within the environment of the UE 215-a (e.g., within the wireless communications system 200). Such reflectors may be examples of objects or surfaces illustrated by and described with reference to FIG. 3. Accordingly, the UE 215-a may experience SI 260 due to the signal leakage and the clutter reflections. The SI 260 may impact (e.g., interfere with) the downlink signaling 266.

Clutter interference experienced at a device may vary (e.g., change) based on the environment of the device. For example, the environment of the UE 215-a may include a first set of reflectors (e.g., buildings, metallic surfaces). In such an example, the UE 215-a may experience a first level of clutter interference (e.g., based on a quantity of clutter reflections or an intensity of clutter reflections off the first quantity of reflectors). In some examples, however, the environment of the UE 215-a may change, for example, due to reflectors being introduced or removed from the environment. Additionally, or alternatively, the UE 215-a may be mobile (e.g., capable of moving locations, rotating, or otherwise changing a position of the UE 215-a or one or more components of the UE 215-a) and the environment of the UE 215-a may change, for example, due to a change in the location (or position) of the UE 215-a or the network entity 205. In such examples, the environment (e.g., the changed environment) of the UE 215-a may include a second set of reflectors, which may be different from the first set of reflectors (e.g., may include a different quantity or type of reflectors). In such an example, the UE 215-a may experience a second level of clutter interference (e.g., a based on a quantity of clutter reflections or an intensity of clutter reflections off the second set of reflectors), which may be different from (e.g., more or less than) the first level of clutter interference. In other words, the strength or quantity of clutter reflection may be variable depending on the environment of the UE 215-a and, therefore, the level of clutter interference experienced at the UE 215-a may change based on a location the UE 215-a may be transmitting to (e.g., a location or position of the network entity 205) or a location the UE 215-a may be transmitted from (e.g., a location or position of the UE 215-a). The change in the level of clutter interference experienced at the UE 215-a (e.g., a change in a clutter profile at the UE 215-a) may correspond to a change in the SI 260. As such, the clutter profile (e.g., clutter reflections), which may be representative of the level of clutter interference at the UE 215-a, may impact (e.g., be a difficulty for) full-duplex operations at the UE 215-a (e.g., for full-duplex nodes).

For example, digital interference cancellation complexity (e.g., a complexity of the IC 245) may increase with increases in the clutter profile complexity (e.g., increases in clutter interference, increases in clutter reflections). The UE 215-a (or the network entity 205) may support one or more techniques for cancelling (or otherwise mitigating) clutter interference, such as using NLIC. An increase in the level of clutter interference experienced at the UE 215-a (e.g., the quantity or strength of taps included in the clutter profile) may increase a complexity of the NLIC (e.g., or other digital interference cancellation techniques deployed at the UE 215-a) used to mitigate the clutter interference. Consequently, the UE 215-a may be capable of canceling clutter interference up to a threshold level of interference that the NLIC may be capable of mitigating (e.g., due to hardware and software constraints). In some examples, the level of clutter interference experienced at the UE 215-a may exceed the threshold level of interference capable of being mitigated via the NLIC.

For example, a full-duplex capable UE (e.g., the UE 215-a) may support full-duplex operations for (e.g., up to) a threshold level of interference. Accordingly, the full-duplex capability of the UE 215-a may depend on the clutter profile at the UE 215-a and, therefore, the environment of the UE 215-a (e.g., because the clutter profile is variable based on the environment and mobility of the UE 215-a itself). In other words, the full-duplex capability of the UE 215-a may be subject to change based on the clutter profile (e.g., the level of clutter interference, and thus the SI 260) experienced at the UE 215-a. That is, the UE 215-a may be unable to transmit the uplink signaling 265 while simultaneously receiving the downlink signaling 266 if the UE 215 is unable to mitigate (e.g., sufficiently cancel or remove) the SI 260, for example, due to the level of clutter interference experienced at the UE 215-a exceeding a threshold level of interference capable of being mitigated at the UE 215-a (e.g., based on hardware or software constraints at the UE 215-a). For example, NLIC capabilities supported at the UE 215-a may enable the UE 215-a to cancel a particular level of interference (e.g., a threshold level of interference based on the quantity, strength, or a combination of the strength and quantity of taps included in the clutter profile).

In some examples, the level of clutter interference experienced at the UE 215-a may satisfy (e.g., may exceed, may be above) the threshold. For example, the clutter profile may include a larger quantity of taps or may include taps with a higher intensity than is capable of being mitigated (e.g., processed) via the NLIC. In such examples, NLIC at the UE 215-a may fail to mitigate the interference (e.g., NLIC may not be feasible or a performance of the NLIC at the UE 215-a may be reduced, such that the NLIC may be insufficient). Consequently, the full-duplex capability at the UE 215-a may be modified. For example, the UE 215-a may be incapable of full-duplex operations (e.g., the UE 215-a may operate in a half-duplex mode) or full-duplex capabilities of the UE 215-a may be reduced (e.g., the UE 215-a may operate in a full-duplex mode with one or more constraints). In some other examples, the level of clutter interference experienced at the UE 215-a may fail to satisfy (e.g., may fail to exceed, may be below) the threshold. For example, the clutter profile may include a smaller quantity of taps or may include taps with a lower intensity than is capable of being mitigated (e.g., processed) via the NLIC. In such examples, NLIC at the UE 215-a may successfully (e.g., sufficiently) mitigate the interference. Consequently, the duplex capability at the UE 215-a may be modified. For example, the UE 215-a may transition from half-duplex operations to full-duplex operations or the full-duplex capabilities of the UE 215-a may be increased (e.g., the UE 215-a may operate in a full-duplex mode without or with fewer constraints). In other words, the UE 215-a may modify the duplex capability of the UE 215-a based on the clutter profile at the UE 215-a.

In some examples, the duplex capability of the UE 215-a may correspond to an SBFD capability of the UE 215-a. For example, based on a clutter profile obtained at the UE 215-a, the UE 215-a may determine that the level of clutter interference experienced at the UE 215-a satisfies a threshold. In such examples, the UE 215-a may modify the SBFD capability at the UE 215-a. For example, the UE 215-a may determine to refrain from operating in an SBFD mode (e.g., may determine to transition from an SBFD mode to a half-duplex mode). In such an example, the UE 215-a may be SBFD-aware. In some other examples, the UE 215-a may determine to operate in the SBFD mode with one or more constraints, such as with an increased larger guard band or with a reduced transmit power.

In some examples, a clutter profile may be referred to as a CIR. The UE 215-a may determine the clutter profile using one or more techniques, such as sensing or channel estimation. In such an example, however, the network entity 205 may be unaware of the clutter profile (e.g., the level of clutter interference) at the UE 215-a. As such, the network entity 205 may be unaware of a change in a duplex capability (e.g., a full-duplex capability, a half-duplexing capability) of the UE 215-a.

In some examples, the network entity 205 and the UE 215-a may support a framework indicating an update pertaining to SBFD capabilities of the UE 215-a. For example, in accordance with one or more techniques for reporting SBFD capability updates, as described herein, the UE 215-a may transmit an indication of the clutter profile of the UE 215-a to the network entity 205. In some examples, the indication may be an indication of a reduced full-duplex capability (e.g., a reduced SBFD capability) or an increased full-duplex capability (e.g., an increased SBFD capability). That is, the indication may be a UE capability indication that indicates, to the network entity 205, a full-duplex capability of the UE 215-a, which may be reduced or increased relative to a previously reported full-duplex capability of the UE 215-a (or relative to a default full-duplex capability of the UE 215-a). In some other examples, the indication may be UE assistance information that indicates, to the network entity 205, that the UE 215-a is unable (or able) to perform full-duplex operations (e.g., over some duration, such as a duration associated with a time instance at which the indication is transmitted). In some other examples, the indication may be an indication of maintained full-duplex capability at the UE 215-a.

For example, as illustrated in the example of FIG. 2, the UE 215-a may transmit an SBFD indication 275 to the network entity 205 at a first time. The SBFD indication 275 may correspond to a message (e.g., a UE capability message) that includes first information indicative of an SBFD capability of the UE 215-a. The first information may also identify a first duplexing mode for wireless communication by the UE 215-a. For example, the first duplexing mode may correspond to a full-duplex mode and the SBFD capability may correspond to a capability of the UE to perform SBFD in accordance with a first set of parameters (e.g., an initial set of parameters, a default set of parameters). In other words, the SBFD indication 275 may indicate that the UE 215-a is an SBFD UE (e.g., an SBFD capable UE). In such an example, the UE 215-a may communicate a signal (e.g., the uplink signaling 265, the downlink signaling 266, or some other type of signaling that may be transmitted as part of a sensing procedure or channel estimation) using the first duplexing mode in accordance with the SBFD capability of the UE 215-a. The UE 215-a may perform one or more measurements on the signal (e.g., the direct signal, reflections of the signal) to obtain a CIR associated with communicating the signal. In some examples, the UE 215-a may determine whether the UE 215-a is capable of maintaining the first duplexing mode based on the CIR. That is, the UE 215-a may determine whether the UE 215-a is capable of full-duplex operations (e.g., capable of maintaining SBFD in accordance with the first set of parameters) based on measurements at the UE 215-a (e.g., via sensing or channel estimation).

The UE 215-a may transmit an SBFD update indication 270 to the network entity 205 at a second time based on the CIR. The SBFD update indication 270 may correspond to a message including information indicative of an update pertaining to the SBFD capability of the UE 215-a (e.g., capability of the UE 215-a to perform SBFD in accordance with the first set of parameters). In such an example, the update may be based on the CIR and may identify a second duplexing mode for wireless communication by the UE 215-a. The SBFD update indication 270 may be either in the form of control information, such as uplink control information (UCI), or a medium access control-control element (MAC-CE).

In some examples, the SBFD update indication 270 may be relative to the SBFD indication 275. That is, the update indicated via the SBFD update indication 270 may be relative to the first information included in the SBFD indication 275. For example, the update (e.g., the contents of the SBFD update indication 270) may indicate whether the full-duplex capability of the UE 215-a (indicated via the SBFD indication 275) is maintained or not. As an illustrative example, the contents of the SBFD update indication 270 may include a first bit that indicates the full-duplex capability of the UE 215-a is maintained over a duration (e.g., between the first time and the second time) or a second bit that indicates the full-duplex capability of the UE is not maintained over the duration (e.g., SBFD capability of the UE changed, such that the SBFD capability of the UE at the second time is different from the SBFD capability of the UE at the first time).

In some examples, the UE 215-a may determine that the SBFD capability of the UE 215-a is maintained (e.g., that the UE 215-a maintained or is capable of maintaining SBFD in accordance with the first set of parameters). For example, the UE 215-a may determine, that a level of clutter interference at the UE 215-a fails to satisfy a threshold associated with SBFD in accordance with the first set of parameters. In such an example, the update indicated via the SBFD update indication 270 may include that the SBFD capability is maintained at the UE 215-a (e.g., over a duration between the first time and the second time). For example, the contents of the SBFD update indication 270 may include the first bit indicating that the SBFD capability of the UE did not change over the duration between the first time and the second time (e.g., the SBFD capability of the UE at the second time is the same as or about the same as the SBFD capability of the UE at the first time). Accordingly, the second duplexing mode may be the same as the first duplexing mode.

In some other examples, the UE 215-a may identify a modification to the SBFD capability of the UE 215-a based on the CIR. That is, the UE 215-a may detect a change in the SBFD capability at the UE 215-a (e.g., the capability of the UE 215-a to perform SBFD in accordance with the first set of parameters). For example, the UE 215-a may determine, that the level of clutter interference at the UE 215-a satisfies the threshold associated with SBFD in accordance with the first set of parameters. In such an example, the UE 215-a may transmit the SBFD update indication 270 to the network entity 205 in response to the determination. That is, in response to the UE 215-a detecting a change in the SBFD capability at the UE 215-a (e.g., the full-duplex capable UE), the UE 215-a may send an indication to the network entity 205 with the change in capability. For example, the update indicated via the SBFD update indication 270 may include that the SBFD capability is not maintained at the UE 215-a over the duration between the first time and the second time. In other words, the update (e.g., the contents of the SBFD update indication 270) may include the second bit that indicates the SBFD capability of the UE 215-a changed over the duration. As described herein, an update that indicates the SBFD capability is not maintained may correspond to an update that indicates that there was a change in the SBFD capability. Accordingly, the second duplexing mode may be different from the first duplexing mode. For example, the second duplexing mode may correspond to a half-duplex mode and the SBFD update indication 270 may indicate that the UE 215-a is SBFD aware (e.g., that the UE 215-a is aware the network entity 205 is operating in SBFD but that the UE 215-a is operating in half-duplex).

In some other examples, the SBFD update indication 270 may indicate that the full-duplex capability of the UE 215-a is modified (e.g., is reduced, is increased). That is, the update indicated via the SBFD update indication 270 may be indicative of a modification to the SBFD capability of the UE 215-a. In such an example, the second duplexing mode may be based on the modification. For example, a duplexing mode used at the UE (e.g., the first duplexing mode, the second duplexing mode) may be based on parameters used at the UE for SBFD and the modification may be associated with one or more of the parameters. For instance, the modification may be associated with a spatial domain parameter, a power domain parameter, or a frequency domain parameter usable at the UE for wireless communications in accordance with one or more duplexing modes. As an illustrative example, the UE 215-a may determine that a level of clutter interference at the UE satisfies the threshold associated with SBFD in accordance with the first set of parameters but fails to satisfy a threshold associated with SBFD in accordance with a second set of parameters. In other words, the UE 215-a may determine that the UE 215-a is capable of supporting SBFD in accordance with a second set of parameters that are different from the first set of parameters. In such an example, the modification may be indicative of the second set of parameters (e.g., may directly indicate the second set of parameters or may indirectly indicate the second set of parameters by indicating a change in the first set of parameters). As an illustrative example, the UE 215-a may determine (e.g., and the SBFD update indication 270 may indicate) that the UE 215-a may support SBFD operations with an increased (e.g., relatively larger) guard band between the uplink sub-band and the downlink sub-band (to reduce clutter interference via increased frequency separation). Additionally, or alternatively, the UE 215-a may determine (e.g., and the SBFD update indication 270 may indicate) that the UE 215-a may support SBFD operations with a reduced transmit power (e.g., with stricter constraints on the uplink power to reduce clutter interference). In some examples, the UE 215-a may determine (e.g., and the SBFD update indication 270 may indicate) that the UE 215-a may support SBFD operations with fewer transmit antennas (e.g., to reduce clutter interference via increased spatial separation). That is, in some examples, the SBFD update indication 270 may indicate that the UE 215-a may perform SBFD with one or more constraints in the spatial domain, power domain, or frequency domain. In such an example, the second duplexing mode may correspond to the same duplexing mode as the first duplexing mode (e.g., may correspond to a full-duplex mode).

In some examples, the SBFD update indication 270 may include one or more bits corresponding to the modification. For example, based on a previously (or initially) reported UE capability (e.g., the UE capability reported via the SBFD indication 275), the UE 215-a may be configured with a table (e.g., an RRC table) that gives a mapping between a bitmap that may be indicated by the UE 215-a and a corresponding capability (e.g., a reduced capability in the form of an increased guard-band, an increased capability in the form of a reduced guard band). That is, the network entity 205 may configure (e.g., via RRC signaling or some other type of control signaling) the UE 215-a with one or more mappings between one or more bits and a one or more modifications. As an illustrative example, to enable the UE 215-a to indicate a modification to a frequency domain parameter, the network entity 205 may configure the UE 215-a with mappings in accordance with the following Table 1:

TABLE 1

| Bits | Modification |
|---|---|
| 00 | A 10 RB (or default) guard band |
| 01 | An increased quantity of RBs relative to |
| | the quantity of RBs indicated via 00 |
| 10 | An increased quantity of RBs relative to |
| | the quantity of RBs indicated via 01 |
| 11 | A 100 MHz (or infinite) guard band |

In some examples, the modification to the SBFD capability may be such that the second duplexing mode is the same as the first duplexing mode. For example, the first set of parameters may correspond to a default set of parameters associated with SBFD. In such an example, the SBFD update indication 270 may include bits 00 to indicate that the SBFD capability of the UE is maintained (e.g., and that the second duplexing mode is the same as the first duplexing mode). Alternatively, in such an example, the SBFD update indication 270 may include bits 01 to indicate that the UE 215-a may support SBFD (and thus the second duplexing mode is the same as the first duplexing mode), but that the SBFD capability of the UE is modified (e.g., reduced) to include the use of an increased (e.g., additional) guard band. In some other examples, the modification to the SBFD capability may be such that the second duplexing mode is different from the first duplexing mode. For example, the SBFD update indication may include the bits 11 to indicate that the UE 215-a may support SBFD with a 100 MHz (or infinite) guard band, which may result in the duplexing capability of the UE 215-a being (e.g., converging to) a half-duplex mode. That is, the modification to the SBFD capability of the UE 215-a may result in the second duplexing mode being a half-duplex mode. In some examples, a modification indicated via one or more bit mappings may correspond to a level of SBFD capability. For example, a first level of SBFD capability may correspond to SBFD in accordance with a first set of parameters (e.g., including a 10 RB guard band) and a second level of SBFD capability may correspond to SBFD in accordance with a second set of parameters (e.g., including a guard band with more than 10 RBs).

FIG. 3 shows an example of a wireless communications system 300 that supports techniques for reporting SBFD capability updates in accordance with one or more aspects of the present disclosure. The wireless communications system 300 may implement or be implemented at one or more aspects the wireless communications system 100 and the wireless communications system 200. For example, the wireless communications system 300 may include a device 305-a and a device 305-b, which may be examples of a UE or a network entity illustrated by and described with reference to FIGS. 1 and 2. The device 305-a and the device 305-b may communicate one or more signals. That is, the device 305-b may transmit a signal to, or receive a signal from, the device 305-a. In some examples, a transmitting device may be referred to as an initiating device and a receiving device may be referred to as a responding device. As illustrated in the example of FIG. 3, the device 305-b may transmit a signal via a transmit array at the device 305-b. The transmit array may be an example of a transmit array illustrated by and described with reference to FIG. 2.

The device 305-b may obtain (e.g., estimate) a CIR 308 associated with transmission of the signal to the device 305-a. In some examples, the CIR 308 (e.g., the profile of taps 310) may be an example of a clutter profile as described with reference to FIG. 2. The device 305-b may perform one or more measurements of the signal (e.g., the reflections of the signal) to obtain the CIR 308. The CIR 308 may represent or characterize signals (e.g., direct signals, reflections of direct signals, reflections of signals off one or more objects) as one or more of the taps 310. The taps 310 may indicate a strength (e.g., intensity, amplitude, received power) of one or more signals received at different points in time (such as t0, t1, and so forth). As shown by FIG. 3, the device 305-b may generate the CIR 308 that includes one or more of the taps 310. Each of the taps 310 may refer to an energy rise in the CIR at a point in time (e.g., a time instance) or at an occasion that may indicate a direct or reflected signal. The transmitted signal may be reflected off one or more objects within the wireless communications system 300, such as the device 305-a, an object 306 (e.g., a user, another human, a body part, an animal, a robot, a building), and a surface 307. In such an example, the device 305-b may receive (e.g., detect) one or more reflections of the signal via a receive array of the device 305-b. The receive array may be an example of a receive array illustrated by and described with reference to FIG. 2. For example, the device 305-b may receive a reflection of the direct signal, as well as reflections of the signal off of the object 306 and the surface 307.

In other words, the device 305-b (e.g., a UE) may transmit the signal (e.g., an impulse signal) and, as a result of the transmission, may receive multiple reflections (e.g., taps 310). For example, a first duration after transmission of the signal (e.g., at a time to), the device 305-b may detect a first reflection corresponding to a first tap. In some examples, the first tap may be a largest tap among the taps 310. For example, the first tap may correspond to the direct path of the signal (e.g., the reflection of the direct signal). The device 305-b may also detect one or more other reflections corresponding to one or more other taps (e.g., of varying amplitudes). For example, a second duration after transmission of the signal (e.g., at a time t₁) the device 305-b may receive a second reflection corresponding to a second tap. The second tap may be smaller than the first tap (e.g., an amplitude of the second tap may be smaller than an amplitude of the first tap). The second tap may correspond to a reflection off the object 306 or the surface 307. A third duration after transmission of the signal (e.g., at a time t₂) the device 305-b may receive a third reflection corresponding to a third tap. The third tap may be larger than the second tap (e.g., an amplitude of the second tap may be smaller than an amplitude of the third tap). The third tap may correspond to a reflection off the object 306 or the surface 307. A fourth duration after transmission of the signal (e.g., at a time t3) the device 305-b may receive a fourth reflection corresponding to a fourth tap. The fourth tap may be smaller than the third tap (e.g., an amplitude of the fourth tap may be smaller than an amplitude of the third tap). The fourth tap may correspond to a reflection off the object 306 or the surface 307. In some examples, the reflections detected at the device 305-b may be examples of clutter reflections (or more simply, clutter) as described with reference to FIG. 2. Accordingly, the device 305-b may experience a level of clutter interference, which may be based on some combination of both the strength (e.g., amplitude, intensity) and quantity of the taps 310. In some examples, one or more of the taps 310 may appear for detected energy that is not part of a direct or reflected signal. For example, one or more of the taps 310 may be due to interfering energy or other noise. That is, one or more of the taps 310 may correspond to interference, such as adjacent channel interference (ACI). In other words, one or more of the taps may correspond to a direct signal, a reflected signal (for example, a reflection of the direct signal), or an interfering signal (also referred to as an interferer).

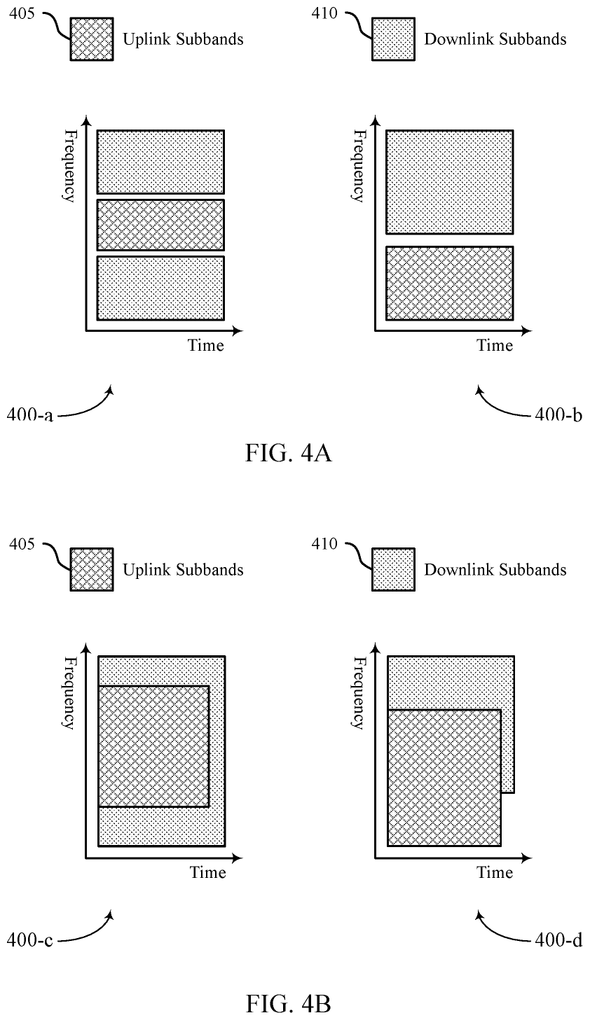

FIGS. 4A and 4B illustrate examples of a TTI configuration 400 that supports techniques for reporting SBFD capability updates in accordance with one or more aspects of the present disclosure. The TTI configuration 400 (e.g., a TTI configuration 400-a, a TTI configuration 400-b, a TTI configuration 400-c, and a TTI configuration 400-d) may be implemented at one or more aspects of the wireless communications system 100, the wireless communications system 200, and the wireless communications system 300. For example, the TTI configurations 400 may be implemented at a network entity or a UE, which may be examples of the corresponding devices as discussed with reference to FIGS. 1 through 3. The TTI configurations 400 may include features for improved communications between the network entity and the UE, among other possible benefits.

A device may support full-duplex communications in accordance with one or more of the TTI configurations 400. In some examples, the TTI configurations 400 may be examples of slots or symbols. That is, as described herein, a TTI may correspond to a slot duration or a symbol duration. In accordance with a full-duplex operation mode, the device may transmit and receive at the same time. For example, the device may be a UE and, as such, may transmit uplink communications, while simultaneously receiving downlink. In such examples, to reduce overhead, the UE may support the TTI configurations 400, which may provide for a configured downlink opportunity and a configured uplink opportunity to coexist on a TTI (e.g., a same symbol, a same slot).

As illustrated in the example of FIG. 4A, the device may support SBFD communications, in which the device may be configured with multiple (e.g., different) frequency resources for uplink and downlink communications. SBFD may also be referred to as flexible duplex or sub-band FDD. For example, the device may be configured with downlink resources that are separated from (e.g., non-overlapping with) uplink resources in the frequency domain. In such an example, the device may transmit and receive at the same time, but on different frequency resources. For example, the TTI configuration 400-a and the TTI configuration 400-b, which may be referred to as SBFD slots or symbols, may provide for an uplink opportunity using uplink sub-bands 405 and downlink opportunities using downlink sub-bands 410. That is, the uplink sub-band 405 may include uplink resources and the downlink sub-bands 410 may include downlink resources. For example, the device may receive an indication of uplink resources for transmission of an uplink signal using one of the uplink sub-bands 405 and downlink resources for reception of a downlink signal using one or more of the downlink sub-band 410. In some examples, the uplink sub-bands 405 and the downlink sub-bands 410 may correspond to respective component carriers within a same radio frequency spectrum band (e.g., within a bandwidth). In some examples, within a TTI (e.g., in accordance with the TTI configuration 400-a or the TTI configuration 400-b) one of the downlink sub-bands 410 and one of the uplink sub-bands may be separated by a guard band.

Additionally, or alternatively, as illustrated in the example of FIG. 4B, the device may support IBFD, in which the device may be configured with at least some of the same frequency domain resources for uplink and downlink communications. For example, time and frequency resources configured (e.g., at the device) for downlink communications may overlap (e.g., partially overlap, fully overlap) with time and frequency resources configured for uplink communications. In other words, downlink and uplink may share the same time and frequency resources (e.g., IBFD resources). In such an example, the device may transmit and receive at the same time, on the same frequency resources. For example, the TTI configuration 400-c and the TTI configuration 400-d, which may be referred to as IBFD slots or symbols, may provide for an uplink opportunity using uplink sub-bands 405 and downlink opportunities using downlink sub-bands 410. That is, the uplink sub-band 405 may include uplink resources and the downlink sub-bands 410 may include downlink resources. For example, the device may receive an indication of uplink resources for transmission of an uplink signal using one of the uplink sub-bands 405 (e.g., in accordance with the TTI configuration 400-c or the TTI configuration 400-d) and downlink resources for reception of a downlink signal using one of the downlink sub-band 410 (e.g., in accordance with the TTI configuration 400-c or the TTI configuration 400-d).

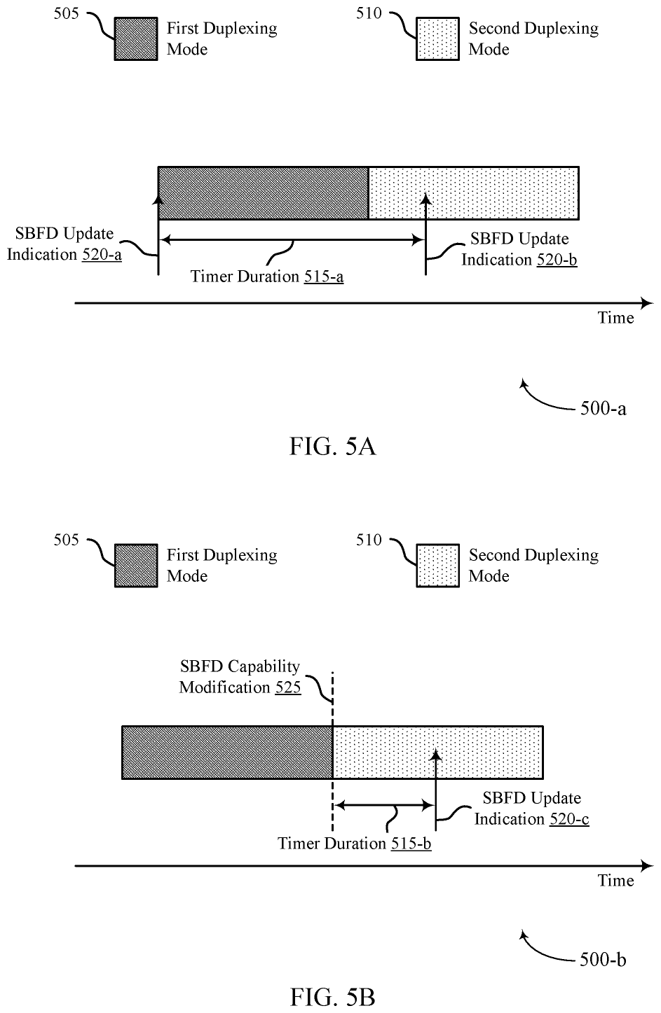

FIGS. 5A & 5B each show an example of a timing diagram 500 that supports techniques for reporting SBFD capability updates in accordance with one or more aspects of the present disclosure. The timing diagrams 500 (e.g., a timing diagram 500-a, a timing diagram 500-b) may be implemented at one or more aspects of the wireless communications system 100, the wireless communications system 200, the wireless communications system 300, and the TTI configurations 400. For example, the timing diagrams 500 may be implemented at a network entity or a UE, which may be examples of the corresponding devices as discussed with reference to FIGS. 1 through 3, 4A, and 4B. The timing diagrams 500 may include features for improved communications between the network entity and the UE, among other possible benefits.

In some examples, the network entity and the UE may support a framework for indicating an update pertaining to SBFD capabilities of the UE. For example, in accordance with one or more techniques for reporting SBFD capability updates, as described herein, the UE may transmit an SBFD update indication to the network entity. The SBFD update indication may be an example of an SBFD update indication illustrated by and described with reference to FIG. 2. For example, the SBFD update indication may indicate whether an SBFD capability of the UE is maintained at the UE over a duration. Alternatively, the SBFD update indication may indicate a modification to an SBFD capability of the UE (e.g., a reduced SBFD capability or an increased SBFD capability of the UE).

In some examples, the UE may transmit an SBFD update indication 520 (e.g., an indication of change of full-duplex capability) based on the UE detecting a change of its capability (e.g., based on one or more measurements, based on a CIR obtained at the UE via one or more measurements). For example, the UE may perform measurements (e.g., sensing measurements) and transmit an indication of a change in the capability of the UE in response to detecting the change. In such an example, conditions experienced at the UE (e.g., the environment of the UE) may change relatively frequently, which may lead to the UE detecting a change in the full-duplex capability relatively frequently. For example, the UE may move relatively frequently and, as such, the environment (and duplexing capability) of the UE may change relatively frequently. In such an example, the UE may be configured with a timer (e.g., regulations) for managing such changes (e.g., the relatively frequent changes). That is, the UE may be configured with a timer to avoid frequent indications of capability changes. In other words, to avoid frequent switches in full-duplex capability, one of the following options should be followed:

As illustrated in the example of FIG. 5A, the UE may transmit an SBFD update indication 520-a to the network entity at a first time. The SBFD update indication 520-a may be an example of an SBFD update indication or an SBFD indication illustrated by and described with reference to FIG. 2. For example, the SBFD update indication 520-a may indicate an initial SBFD capability of the UE or an update (e.g., change) to an initial SBFD capability of the UE. In the example of FIG. 5A, the SBFD update indication 520-a may indicate that the UE supports a first duplexing mode 505 in accordance with the SBFD capability of the UE. In response to transmitting the SBFD update indication 520-a (e.g., based on a change of the SBFD capability of the UE) the UE may refrain from indicating another change associated with the SBFD capability of the UE for a given time determined by a timer. That is, in response to transmitting the SBFD update indication 520-a, the UE may initiate a timer and may refrain from transmitting another SBFD update indication over a duration of the timer (e.g., a timer duration 515-a). Accordingly, the UE may determine to transmit an SBFD update indication 520-b based on an expiration of the timer duration 515-a. That is, the UE may detect a change (e.g., modification) to the SBFD capability of the UE (e.g., may detect a change from a first SBFD capability that supports the first duplexing mode 505 to a second SBFD capability that supports a second duplexing mode 510) prior to the expiration of the timer duration 515-a and may transmit the SBFD update indication 520-b indicating the change based on (e.g., in response to) the expiration of the timer duration 515-a.

As illustrated in the example of FIG. 5B, the UE may identify an SBFD modification 525 (e.g., a modification to the SBFD capability of the UE) at a first time. In such an example, the UE may initiate a timer in response to identifying the SBFD modification 525 and may indicate the SBFD modification 525 to the network entity (e.g., via an SBFD update indication 520-c) based on the SBFD modification 525 being maintained at the UE over a duration of the timer (e.g., a timer duration 515-b). In other words, the UE may indicate a change of the SBFD capability of the UE in response to the change in the SBFD capability (e.g., the second duplexing mode 510) being maintained for a particular time (e.g., the timer duration 515-b) that may be managed via a timer. In some examples, the timer may be configured by the network entity via RRC signaling. For example, the timer duration 515-b may be configured via the network entity as (e.g., in terms of) a quantity of TTIs (e.g., a quantity of symbols, a quantity of slots).

In some other examples, the UE may be configured with periodic reporting in accordance with an RRC configured periodicity. For example, the network entity may configure the UE to transmit one or more of the SBFD update indications in accordance with a periodicity, such that the UE may perform measurements according to the periodicity (and may refrain from performing measurements over a relatively long duration). In some examples, by configuring the UE to report one or more of the SBFD update indications 520 periodically, the network entity may coordinate the SBFD update reporting with other communications scheduled for the UE (or one or more other UEs).

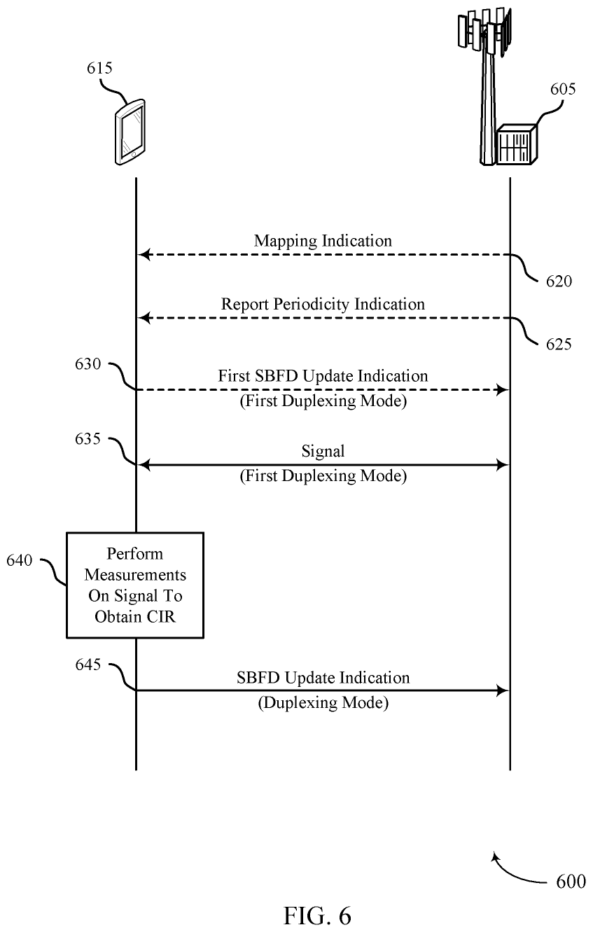

FIG. 6 shows an example of a process flow 600 that supports techniques for reporting SBFD capability updates in accordance with one or more aspects of the present disclosure. The process flow 600 may implement or may be implemented by aspects of the wireless communications system 100, the wireless communications system 200, the wireless communications system 300, the TTI configurations 400, or the timing diagrams 500. For example, the process flow 600 may include a UE 615 and a network entity 605, which may be examples of the corresponding devices illustrated by and described with reference to FIGS. 1 through 3, 4A, 4B, 5A, and 5B. The operations performed at the UE 615 and the network entity 605 may support improvements to communications between the UE 615 and the network entity 605, among other benefits. In the following description of the process flow 600, the operations performed at the UE 615 and the network entity 605 may occur in a different order than the example order shown. Additionally, the operations performed at the UE 615 and the network entity 605 may be performed at different times. Some operations may be combined, and some operations may be omitted. In some examples, the UE 615 and the network entity 605 may support a framework indicating an update pertaining to SBFD capabilities of the UE 615.

At 635, the UE 615 may communicate a signal using a first duplexing mode in accordance with an SBFD capability of the UE 615. The SBFD capability of the UE may be an example of an SBFD capability described with reference to FIG. 2. For example, the SBFD capability may be associated with a first set of parameters.

At 640, the UE 615 may perform one or more measurements on the signal to obtain a CIR associated with communicating the signal. The CIR may be an example of a CIR illustrated by and described with reference to FIG. 3. For example, the CIR may correspond to a clutter profile (e.g., may represent or characterize signals as one or more taps).

At 640, the UE 615 may transmit an SBFD update indication to the network entity 605. The SBFD update indication may be an example of an SBFD update indication illustrated by and described with reference to FIGS. 2, 5A, and 5B. For example, the SBFD update indication may include information indicative of an update pertaining to the SBFD capability of the UE 615. The update may be based on the CIR and may identify a duplexing mode for wireless communication by the UE 615. In some examples, the update may be relative to a previous (or initial) SBFD update indication.

For example, at 630, the UE 615 may transmit a first SBFD update indication at a first time. The first SBFD update indication may include first information that is indicative of the SBFD capability of the UE 615 and may identify the first duplexing mode for wireless communication by the UE 615. In such an example, the SBFD update indication may be transmitted at a second time subsequent to the first time, and the update indicated via the SBFD update indication may be relative to the first information. In some examples, the information included in the SBFD update indication (e.g., the information indicative of the update) may include a bit corresponding to the update.

For example, at 620, the UE 615 may receive a mapping indication indicative of a mapping between at least the bit and the update pertaining to the SBFD capability of the UE 615. The mapping may be an example of a mapping described with reference to FIG. 2. For example, the mapping indication may be received at the UE 615 via RRC signaling. In such an example, the information including the bit may be in accordance with the mapping. That is, the bit included in the SBFD update indication may be based on the bit being mapped to the update in accordance with the mapping.

In some examples, at 625, the UE 615 may receive a report periodicity indication indicating a periodicity associated with reporting updates pertaining to the SBFD capability of the UE 615. The periodicity may be an example of a periodicity described with reference to FIGS. 5A and 5B. For example, the UE 615 may transmit the SBFD update indication (e.g., at 645) in accordance with the periodicity. That is, the UE 615 may report the SBFD capability or a change in the SBFD capability of the UE in accordance with a periodicity configured at the UE via RRC signaling.

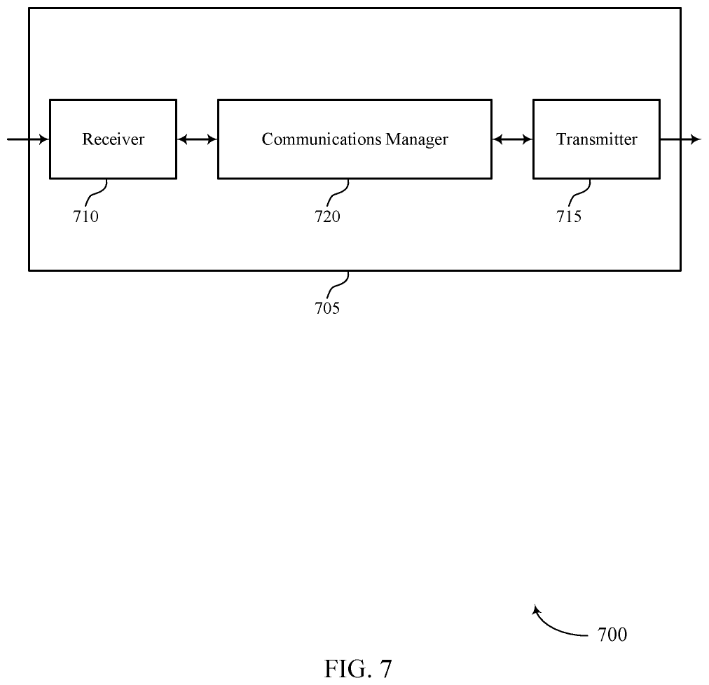

FIG. 7 shows a block diagram 700 of a device 705 that supports techniques for reporting SBFD capability updates in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, and the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for reporting SBFD capability updates). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for reporting SBFD capability updates). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of techniques for reporting SBFD capability updates as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor. If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication in accordance with examples as disclosed herein. For example, the communications manager 720 is capable of, configured to, or operable to support a means for communicating a signal using a first duplexing mode in accordance with an SBFD capability of the UE. The communications manager 720 is capable of, configured to, or operable to support a means for performing one or more measurements on the signal to obtain a CIR associated with communicating the signal. The communications manager 720 is capable of, configured to, or operable to support a means for transmitting a message including information indicative of an update pertaining to the SBFD capability of the UE, where the update is based on the CIR and identifies a second duplexing mode for wireless communication by the UE.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for more efficient utilization of communication resources.

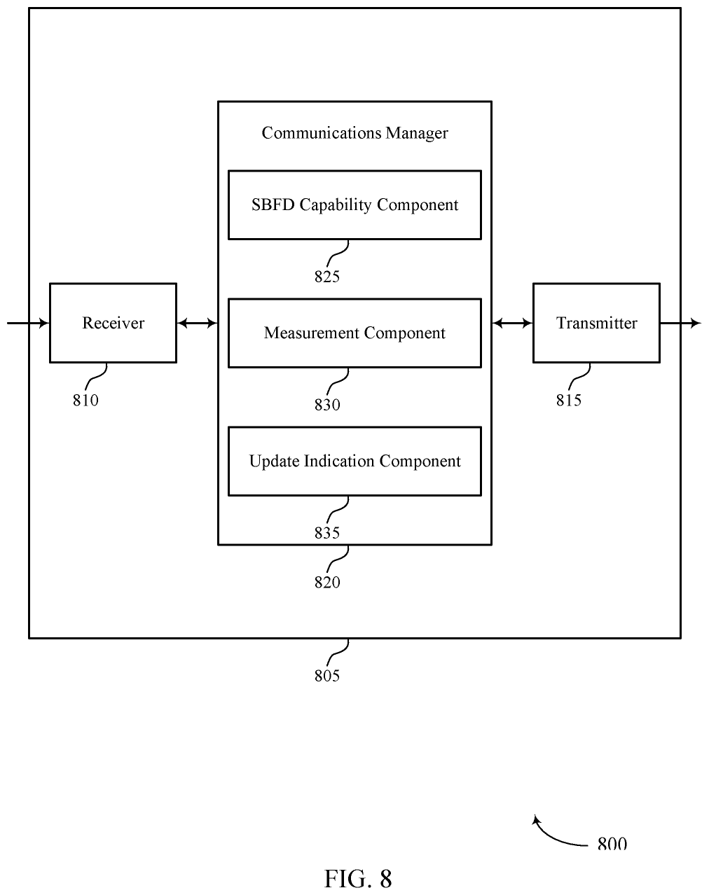

FIG. 8 shows a block diagram 800 of a device 805 that supports techniques for reporting SBFD capability updates in accordance with one or more aspects of the present disclosure. The device 805 may be an example of aspects of a device 705 or a UE 115 as described herein. The device 805 may include a receiver 810, a transmitter 815, and a communications manager 820. The device 805, or one of more components of the device 805 (e.g., the receiver 810, the transmitter 815, and the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for reporting SBFD capability updates). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for reporting SBFD capability updates). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of techniques for reporting SBFD capability updates as described herein. For example, the communications manager 820 may include an SBFD capability component 825, a measurement component 830, an update indication component 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication in accordance with examples as disclosed herein. The SBFD capability component 825 is capable of, configured to, or operable to support a means for communicating a signal using a first duplexing mode in accordance with an SBFD capability of the UE. The measurement component 830 is capable of, configured to, or operable to support a means for performing one or more measurements on the signal to obtain a CIR associated with communicating the signal. The update indication component 835 is capable of, configured to, or operable to support a means for transmitting a message including information indicative of an update pertaining to the SBFD capability of the UE, where the update is based on the CIR and identifies a second duplexing mode for wireless communication by the UE.

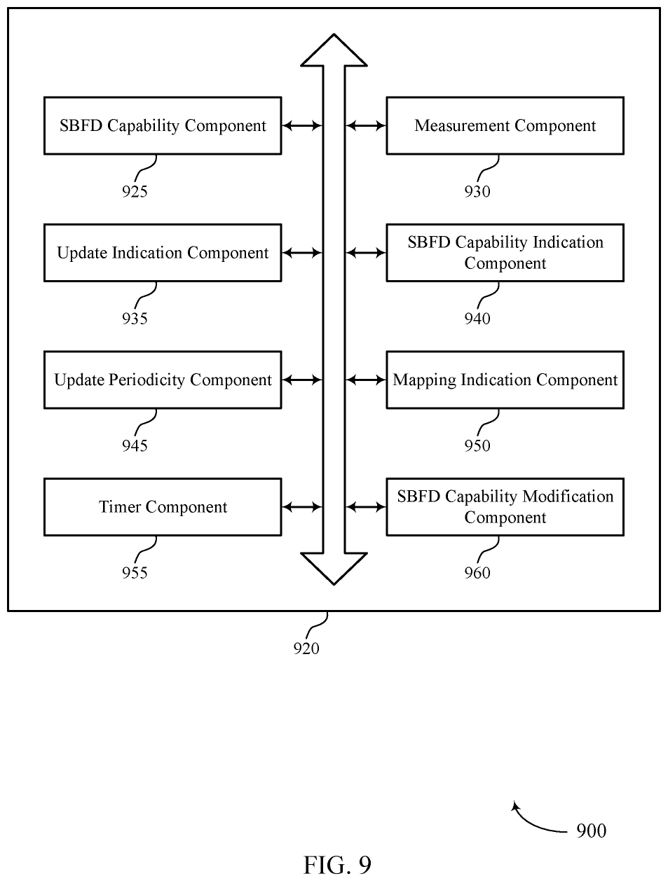

FIG. 9 shows a block diagram 900 of a communications manager 920 that supports techniques for reporting SBFD capability updates in accordance with one or more aspects of the present disclosure. The communications manager 920 may be an example of aspects of a communications manager 720, a communications manager 820, or both, as described herein. The communications manager 920, or various components thereof, may be an example of means for performing various aspects of techniques for reporting SBFD capability updates as described herein. For example, the communications manager 920 may include an SBFD capability component 925, a measurement component 930, an update indication component 935, an SBFD capability indication component 940, an update periodicity component 945, a mapping indication component 950, a timer component 955, an SBFD capability modification component 960, or any combination thereof. Each of these components, or components or subcomponents thereof (e.g., one or more processors, one or more memories), may communicate, directly or indirectly, with one another (e.g., via one or more buses).

The communications manager 920 may support wireless communication in accordance with examples as disclosed herein. The SBFD capability component 925 is capable of, configured to, or operable to support a means for communicating a signal using a first duplexing mode in accordance with an SBFD capability of the UE. The measurement component 930 is capable of, configured to, or operable to support a means for performing one or more measurements on the signal to obtain a CIR associated with communicating the signal. The update indication component 935 is capable of, configured to, or operable to support a means for transmitting a message including information indicative of an update pertaining to the SBFD capability of the UE, where the update is based on the CIR and identifies a second duplexing mode for wireless communication by the UE.

In some examples, the SBFD capability indication component 940 is capable of, configured to, or operable to support a means for transmitting a first message at a first time, the first message including first information that is indicative of the SBFD capability of the UE and that identifies the first duplexing mode for wireless communication by the UE, where the message is transmitted at a second time subsequent to the first time, and where the update is relative to the first information.

In some examples, the update includes that the SBFD capability is maintained at the UE over a duration between the first time and the second time. In some examples, the second duplexing mode is the same as the first duplexing mode based on the SBFD capability being maintained.

In some examples, the update includes that the SBFD capability is not maintained at the UE over a duration between the first time and the second time. In some examples, the second duplexing mode is different than the first duplexing mode based on the SBFD capability not being maintained.

In some examples, the message is transmitted to a network entity. In some examples, the update indicates an expectation that the UE is operating in accordance with the second duplexing mode and the network entity is operating in accordance with the first duplexing mode.

In some examples, the information is indicative of a modification to the SBFD capability of the UE. In some examples, the second duplexing mode is based on the modification. In some examples, the modification is associated with at least one of a spatial domain parameter, a power domain parameter, or a frequency domain parameter usable at the UE for wireless communications in accordance with one or more duplexing modes. In some examples, the modification is based on the CIR satisfying a threshold. In some examples, the information includes at least one bit corresponding to the update.

In some examples, the mapping indication component 950 is capable of, configured to, or operable to support a means for receiving a second message including second information indicative of a mapping between the at least one bit and the update, where the information including the at least one bit is in accordance with the mapping.

In some examples, the second information is indicative of a set of multiple mappings between a set of multiple bits and a set of multiple updates. In some examples, the set of multiple mappings includes at least the mapping. In some examples, transmitting the message is based on an expiration of a timer.

In some examples, the SBFD capability indication component 940 is capable of, configured to, or operable to support a means for transmitting a first message including first information that is indicative of the SBFD capability of the UE and that identifies the first duplexing mode for wireless communication by the UE. In some examples, the timer component 955 is capable of, configured to, or operable to support a means for initiating the timer in response to transmitting the first message.

In some examples, the SBFD capability modification component 960 is capable of, configured to, or operable to support a means for identifying a modification to the SBFD capability of the UE based on the CIR. In some examples, the timer component 955 is capable of, configured to, or operable to support a means for initiating the timer in response to identifying the modification, where transmitting the message is based on the modification being maintained at the UE over a duration of the timer.

In some examples, the timer component 955 is capable of, configured to, or operable to support a means for receiving an indication of a quantity TTIs, where the timer is based on the quantity of TTIs. In some examples, the update periodicity component 945 is capable of, configured to, or operable to support a means for receiving an indication of a periodicity associated with reporting updates pertaining to the SBFD capability of the UE, where transmitting the message is in accordance with the periodicity. In some examples, the information includes an indication of the second duplexing mode. In some examples, the information includes UCI or a MAC-CE.

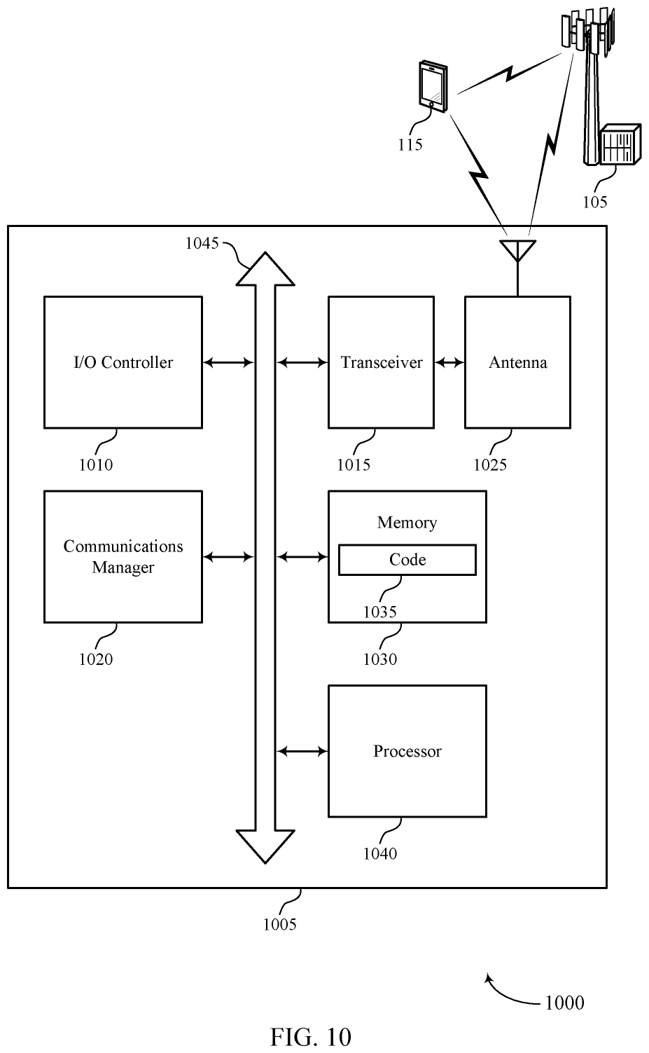

FIG. 10 shows a diagram of a system 1000 including a device 1005 that supports techniques for reporting SBFD capability updates in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable code 1035 including instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may contain, among other things, a basic I/O system (BIOS) which may control basic hardware or software operation such as the interaction with peripheral components or devices.

The at least one processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting techniques for reporting SBFD capability updates). For example, the device 1005 or a component of the device 1005 may include at least one processor 1040 and at least one memory 1030 coupled with or to the at least one processor 1040, the at least one processor 1040 and at least one memory 1030 configured to perform various functions described herein. In some examples, the at least one processor 1040 may include multiple processors and the at least one memory 1030 may include multiple memories. One or more of the multiple processors may be coupled with one or more of the multiple memories, which may, individually or collectively, be configured to perform various functions herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. As such, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code stored in the at least one memory 1030 or otherwise, to perform one or more of the functions described herein.

The communications manager 1020 may support wireless communication in accordance with examples as disclosed herein. For example, the communications manager 1020 is capable of, configured to, or operable to support a means for communicating a signal using a first duplexing mode in accordance with an SBFD capability of the UE. The communications manager 1020 is capable of, configured to, or operable to support a means for performing one or more measurements on the signal to obtain a CIR associated with communicating the signal. The communications manager 1020 is capable of, configured to, or operable to support a means for transmitting a message including information indicative of an update pertaining to the SBFD capability of the UE, where the update is based on the CIR and identifies a second duplexing mode for wireless communication by the UE.

By including or configuring the communications manager 1020 in accordance with examples as described herein, the device 1005 may support techniques for improved communication reliability, reduced latency, and more efficient utilization of communication resources.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of techniques for reporting SBFD capability updates as described herein, or the at least one processor 1040 and the at least one memory 1030 may be otherwise configured to, individually or collectively, perform or support such operations.

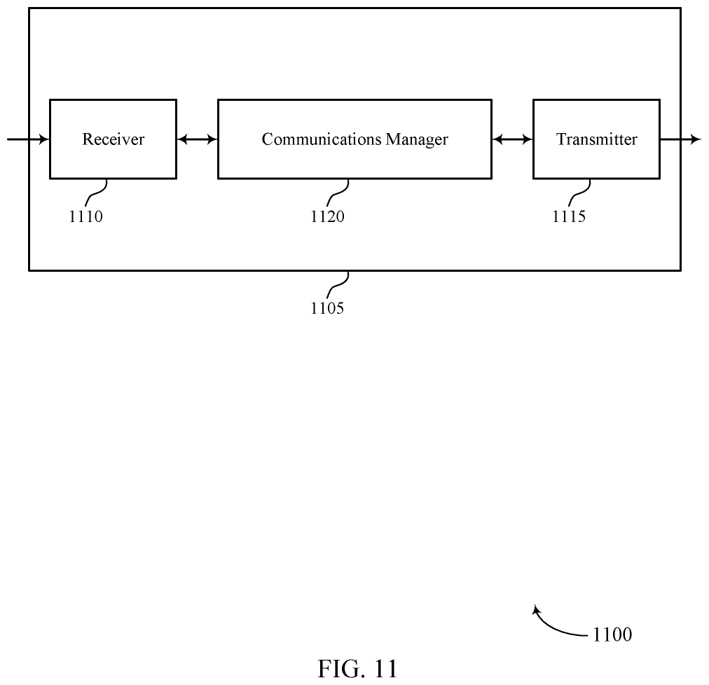

FIG. 11 shows a block diagram 1100 of a device 1105 that supports techniques for reporting SBFD capability updates in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, and the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of techniques for reporting SBFD capability updates as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor. If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication in accordance with examples as disclosed herein. For example, the communications manager 1120 is capable of, configured to, or operable to support a means for communicating a signal between the network entity and a UE in accordance with a first duplexing mode that is based on an SBFD capability of the UE. The communications manager 1120 is capable of, configured to, or operable to support a means for obtaining a message including information indicative of an update pertaining to the SBFD capability of the UE, where the update is based on a CIR associated with communicating the signal, and where the update identifies a second duplexing mode for wireless communication by the UE.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for more efficient utilization of communication resources.

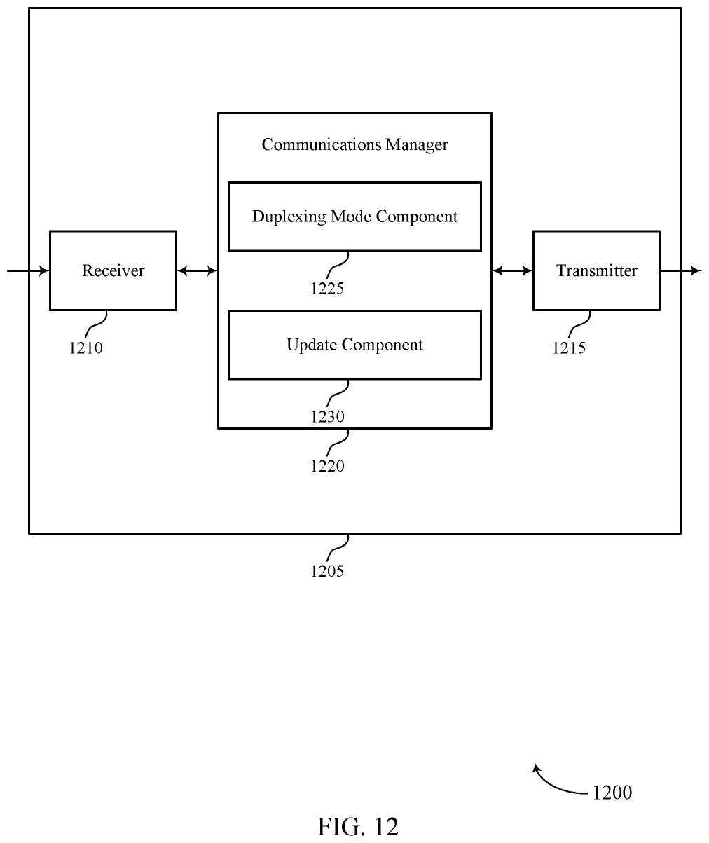

FIG. 12 shows a block diagram 1200 of a device 1205 that supports techniques for reporting SBFD capability updates in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one of more components of the device 1205 (e.g., the receiver 1210, the transmitter 1215, and the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of techniques for reporting SBFD capability updates as described herein. For example, the communications manager 1220 may include a duplexing mode component 1225 an update component 1230, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication in accordance with examples as disclosed herein. The duplexing mode component 1225 is capable of, configured to, or operable to support a means for communicating a signal between the network entity and a UE in accordance with a first duplexing mode that is based on an SBFD capability of the UE. The update component 1230 is capable of, configured to, or operable to support a means for obtaining a message including information indicative of an update pertaining to the SBFD capability of the UE, where the update is based on a CIR associated with communicating the signal, and where the update identifies a second duplexing mode for wireless communication by the UE.

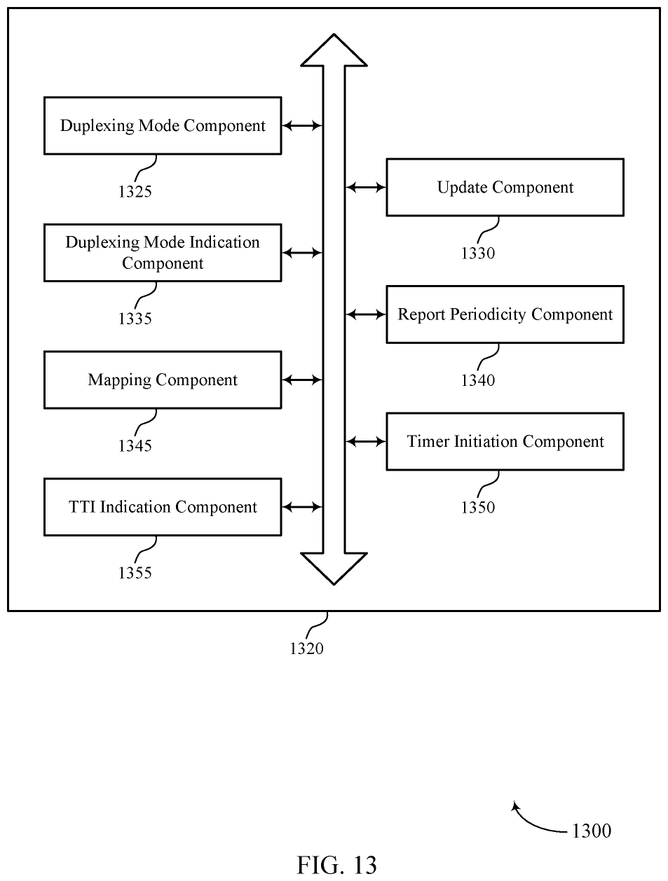

FIG. 13 shows a block diagram 1300 of a communications manager 1320 that supports techniques for reporting SBFD capability updates in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of techniques for reporting SBFD capability updates as described herein. For example, the communications manager 1320 may include a duplexing mode component 1325, an update component 1330, a duplexing mode indication component 1335, a report periodicity component 1340, a mapping component 1345, a timer initiation component 1350, a TTI indication component 1355, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communication in accordance with examples as disclosed herein. The duplexing mode component 1325 is capable of, configured to, or operable to support a means for communicating a signal between the network entity and a UE in accordance with a first duplexing mode that is based on an SBFD capability of the UE. The update component 1330 is capable of, configured to, or operable to support a means for obtaining a message including information indicative of an update pertaining to the SBFD capability of the UE, where the update is based on a CIR associated with communicating the signal, and where the update identifies a second duplexing mode for wireless communication by the UE.

In some examples, the duplexing mode indication component 1335 is capable of, configured to, or operable to support a means for obtaining a first message at a first time, the first message including first information that is indicative of the SBFD capability of the UE and that identifies the first duplexing mode for wireless communication by the UE, where the message is obtained at a second time subsequent to the first time, and where the update is relative to the first information.

In some examples, the update includes that the SBFD capability is maintained at the UE over a duration between the first time and the second time. In some examples, the second duplexing mode is the same as the first duplexing mode based on the SBFD capability being maintained.

In some examples, the update includes that the SBFD capability is not maintained at the UE over a duration between the first time and the second time. In some examples, the second duplexing mode is different than the first duplexing mode based on the SBFD capability not being maintained.

In some examples, the update indicates an expectation that the UE is operating in accordance with the second duplexing mode and the network entity is operating in accordance with the first duplexing mode. In some examples, the information is indicative of a modification to the SBFD capability of the UE. In some examples, the second duplexing mode is based on the modification.

In some examples, the modification is associated with at least one of a spatial domain parameter, a power domain parameter, or a frequency domain parameter usable at the UE for wireless communications in accordance with one or more duplexing modes. In some examples, the modification is based on the CIR satisfying a threshold. In some examples, the information includes at least one bit corresponding to the update.

In some examples, the mapping component 1345 is capable of, configured to, or operable to support a means for outputting a second message including second information indicative of a mapping between the at least one bit and the update, where the information including the at least one bit is in accordance with the mapping.

In some examples, the second information is indicative of a set of multiple mappings between a set of multiple bits and a set of multiple updates. In some examples, the set of multiple mappings includes at least the mapping. In some examples, obtaining the message is based on an expiration of a timer.

In some examples, the duplexing mode indication component 1335 is capable of, configured to, or operable to support a means for obtaining a first message including first information that is indicative of the SBFD capability of the UE and that identifies the first duplexing mode for wireless communication by the UE. In some examples, the timer initiation component 1350 is capable of, configured to, or operable to support a means for initiating the timer in response to obtaining the first message.

In some examples, the TTI indication component 1355 is capable of, configured to, or operable to support a means for outputting an indication of a quantity of TTIs, where the timer is based on the quantity of TTIs.

In some examples, the report periodicity component 1340 is capable of, configured to, or operable to support a means for outputting an indication of a periodicity associated with reporting updates pertaining to the SBFD capability of the UE, where obtaining the message is in accordance with the periodicity.

In some examples, the information includes an indication of the second duplexing mode. In some examples, the information includes UCI or a MAC-CE.

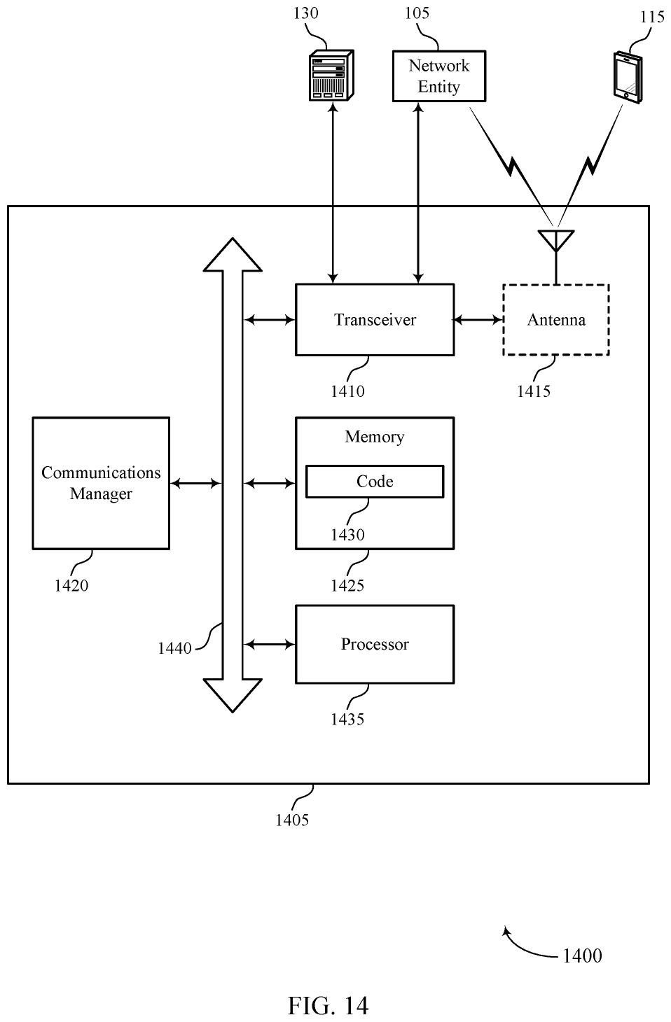

FIG. 14 shows a diagram of a system 1400 including a device 1405 that supports techniques for reporting SBFD capability updates in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., a communication link 125, a backhaul communication link 120, a midhaul communication link 162, a fronthaul communication link 168).

The at least one memory 1425 may include RAM, ROM, or any combination thereof. The at least one memory 1425 may store computer-readable, computer-executable code 1430 including instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may contain, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting techniques for reporting SBFD capability updates). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425). In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. As such, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communication in accordance with examples as disclosed herein. For example, the communications manager 1420 is capable of, configured to, or operable to support a means for communicating a signal between the network entity and a UE in accordance with a first duplexing mode that is based on an SBFD capability of the UE. The communications manager 1420 is capable of, configured to, or operable to support a means for obtaining a message including information indicative of an update pertaining to the SBFD capability of the UE, where the update is based on a CIR associated with communicating the signal, and where the update identifies a second duplexing mode for wireless communication by the UE.

By including or configuring the communications manager 1420 in accordance with examples as described herein, the device 1405 may support techniques for improved communication reliability, reduced latency, and more efficient utilization of communication resources.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of techniques for reporting SBFD capability updates as described herein, or the at least one processor 1435 and the at least one memory 1425 may be otherwise configured to, individually or collectively, perform or support such operations.

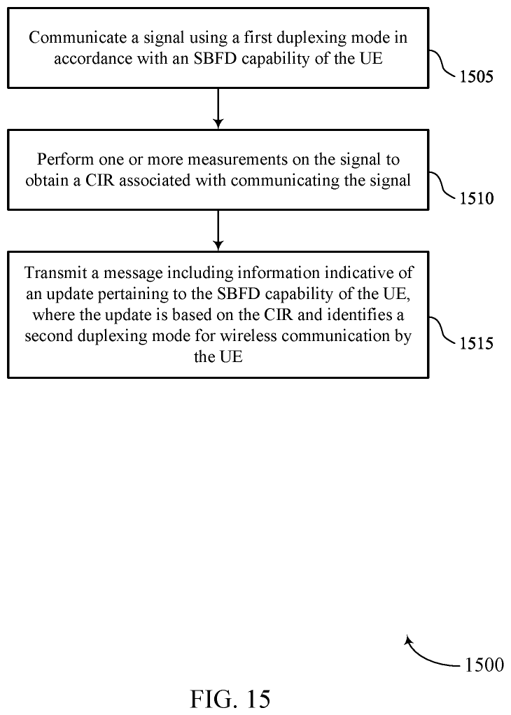

FIG. 15 shows a flowchart illustrating a method 1500 that supports techniques for reporting SBFD capability updates in accordance with aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include communicating a signal using a first duplexing mode in accordance with an SBFD capability of the UE. The operations of block 1505 may be performed in accordance with examples as disclosed herein. In some examples, aspects of the operations of 1505 may be performed by an SBFD capability component 925 as described with reference to FIG. 9.

At 1510, the method may include performing one or more measurements on the signal to obtain a CIR associated with communicating the signal. The operations of block 1510 may be performed in accordance with examples as disclosed herein. In some examples, aspects of the operations of 1510 may be performed by a measurement component 930 as described with reference to FIG. 9.

At 1515, the method may include transmitting a message including information indicative of an update pertaining to the SBFD capability of the UE, where the update is based on the CIR and identifies a second duplexing mode for wireless communication by the UE. The operations of block 1515 may be performed in accordance with examples as disclosed herein. In some examples, aspects of the operations of 1515 may be performed by an update indication component 935 as described with reference to FIG. 9.

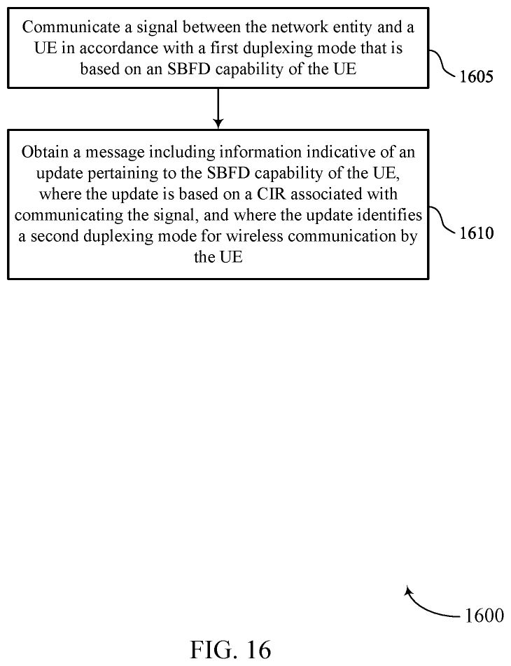

FIG. 16 shows a flowchart illustrating a method 1600 that supports techniques for reporting SBFD capability updates in accordance with aspects of the present disclosure. The operations of the method 1600 may be implemented by a network entity or its components as described herein. For example, the operations of the method 1600 may be performed by a network entity as described with reference to FIGS. 1 through 5 and 11 through 14. In some examples, a network entity may execute a set of instructions to control the functional elements of the network entity to perform the described functions. Additionally, or alternatively, the network entity may perform aspects of the described functions using special-purpose hardware.

At 1605, the method may include communicating a signal between the network entity and a UE in accordance with a first duplexing mode that is based on an SBFD capability of the UE. The operations of block 1605 may be performed in accordance with examples as disclosed herein. In some examples, aspects of the operations of 1605 may be performed by a duplexing mode component 1325 as described with reference to FIG. 13.

At 1610, the method may include obtaining a message including information indicative of an update pertaining to the SBFD capability of the UE, where the update is based on a CIR associated with communicating the signal, and where the update identifies a second duplexing mode for wireless communication by the UE. The operations of block 1610 may be performed in accordance with examples as disclosed herein. In some examples, aspects of the operations of 1610 may be performed by an update component 1330 as described with reference to FIG. 13.

The following provides an overview of aspects of the present disclosure:

Aspect 1: A method for wireless communication by a UE, comprising: communicating a signal using a first duplexing mode in accordance with an SBFD capability of the UE; performing one or more measurements on the signal to obtain a CIR associated with communicating the signal; and transmitting a message comprising information indicative of an update pertaining to the SBFD capability of the UE, wherein the update is based at least in part on the CIR and identifies a second duplexing mode for wireless communication by the UE.

Aspect 2: The method of aspect 1, further comprising: transmitting a first message at a first time, the first message comprising first information that is indicative of the SBFD capability of the UE and that identifies the first duplexing mode for wireless communication by the UE, wherein the message is transmitted at a second time subsequent to the first time, and wherein the update is relative to the first information.

Aspect 3: The method of aspect 2, wherein the update includes that the SBFD capability is maintained at the UE over a duration between the first time and the second time, and the second duplexing mode is the same as the first duplexing mode based at least in part on the SBFD capability being maintained.

Aspect 4: The method of aspect 2, wherein the update includes that the SBFD capability is not maintained at the UE over a duration between the first time and the second time, and the second duplexing mode is different than the first duplexing mode based at least in part on the SBFD capability not being maintained.

Aspect 5: The method of aspect 4, wherein the message is transmitted to a network entity, and the update indicates an expectation that the UE is operating in accordance with the second duplexing mode and the network entity is operating in accordance with the first duplexing mode.

Aspect 6: The method of aspect 1, wherein the information is indicative of a modification to the SBFD capability of the UE, and the second duplexing mode is based at least in part on the modification.

Aspect 7: The method of aspect 6, wherein the modification is associated with at least one of a spatial domain parameter, a power domain parameter, or a frequency domain parameter usable at the UE for wireless communications in accordance with one or more duplexing modes.

Aspect 8: The method of any of aspects 6 through 7, wherein the modification is based at least in part on the CIR satisfying a threshold.

Aspect 9: The method of any of aspects 1 through 8, wherein the information comprises at least one bit corresponding to the update.

Aspect 10: The method of aspect 9, further comprising: receiving a second message comprising second information indicative of a mapping between the at least one bit and the update, wherein the information comprising the at least one bit is in accordance with the mapping.

Aspect 11: The method of aspect 10, wherein the second information is indicative of a plurality of mappings between a plurality of bits and a plurality of updates, and the plurality of mappings includes at least the mapping.

Aspect 12: The method of any of aspects 1 through 11, wherein transmitting the message is based at least in part on an expiration of a timer.

Aspect 13: The method of aspect 12, further comprising: transmitting a first message comprising first information that is indicative of the SBFD capability of the UE and that identifies the first duplexing mode for wireless communication by the UE; and initiating the timer in response to transmitting the first message.

Aspect 14: The method of aspect 12, further comprising: identifying a modification to the SBFD capability of the UE based at least in part on the CIR; and initiating the timer in response to identifying the modification, wherein transmitting the message is based at least in part on the modification being maintained at the UE over a duration of the timer.

Aspect 15: The method of any of aspects 12 through 14, further comprising: receiving an indication of a quantity of TTIs, wherein the timer is based at least in part on the quantity of TTIs.

Aspect 16: The method of any of aspects 1 through 11, further comprising: receiving an indication of a periodicity associated with reporting updates pertaining to the SBFD capability of the UE, wherein transmitting the message is in accordance with the periodicity.

Aspect 17: The method of aspect 1, wherein the information comprises an indication of the second duplexing mode.

Aspect 18: The method of any of aspects 1 through 17, wherein the information comprises UCI or a MAC-CE.

Aspect 19: A method for wireless communication by a network entity, comprising: communicating a signal between the network entity and a UE in accordance with a first duplexing mode that is based at least in part on an SBFD capability of the UE; and obtaining a message comprising information indicative of an update pertaining to the SBFD capability of the UE, wherein the update is based at least in part on a CIR associated with communicating the signal, and wherein the update identifies a second duplexing mode for wireless communication by the UE.

Aspect 20: The method of aspect 19, further comprising: obtaining a first message at a first time, the first message comprising first information that is indicative of the SBFD capability of the UE and that identifies the first duplexing mode for wireless communication by the UE, wherein the message is obtained at a second time subsequent to the first time, and wherein the update is relative to the first information.

Aspect 21: The method of aspect 20, wherein the update includes that the SBFD capability is maintained at the UE over a duration between the first time and the second time, and the second duplexing mode is the same as the first duplexing mode based at least in part on the SBFD capability being maintained.

Aspect 22: The method of aspect 20, wherein the update includes that the SBFD capability is not maintained at the UE over a duration between the first time and the second time, and the second duplexing mode is different than the first duplexing mode based at least in part on the SBFD capability not being maintained.

Aspect 23: The method of aspect 22, wherein the update indicates an expectation that the UE is operating in accordance with the second duplexing mode and the network entity is operating in accordance with the first duplexing mode.

Aspect 24: The method of aspect 19, wherein the information is indicative of a modification to the SBFD capability of the UE, and the second duplexing mode is based at least in part on the modification.

Aspect 25: The method of aspect 24, wherein the modification is associated with at least one of a spatial domain parameter, a power domain parameter, or a frequency domain parameter usable at the UE for wireless communications in accordance with one or more duplexing modes.

Aspect 26: The method of any of aspects 24 through 25, wherein the modification is based at least in part on the CIR satisfying a threshold.

Aspect 27: The method of any of aspects 19 through 26, wherein the information comprises at least one bit corresponding to the update.

Aspect 28: The method of aspect 27, further comprising: outputting a second message comprising second information indicative of a mapping between the at least one bit and the update, wherein the information comprising the at least one bit is in accordance with the mapping.

Aspect 29: The method of aspect 28, wherein the second information is indicative of a plurality of mappings between a plurality of bits and a plurality of updates, and the plurality of mappings includes at least the mapping.

Aspect 30: The method of any of aspects 19 through 29, wherein obtaining the message is based at least in part on an expiration of a timer.

Aspect 31: The method of aspect 30, further comprising: obtaining a first message comprising first information that is indicative of the SBFD capability of the UE and that identifies the first duplexing mode for wireless communication by the UE; and initiating the timer in response to obtaining the first message.

Aspect 32: The method of aspect 30, further comprising: outputting an indication of a quantity of TTIs, wherein the timer is based at least in part on the quantity of TTIs.

Aspect 33: The method of any of aspects 19 through 29, further comprising: outputting an indication of a periodicity associated with reporting updates pertaining to the SBFD capability of the UE, wherein obtaining the message is in accordance with the periodicity.

Aspect 34: The method of aspect 19, wherein the information comprises an indication of the second duplexing mode.

Aspect 35: The method of any of aspects 19 through 34, wherein the information comprises UCI or a MAC-CE.

Aspect 36: A UE for wireless communication, comprising one or more memories storing processor-executable code, and one or more processors coupled with the one or more memories and individually or collectively operable to execute the code to cause the UE to perform a method of any of aspects 1 through 18.

Aspect 37: A UE for wireless communication, comprising at least one means for performing a method of any of aspects 1 through 18.

Aspect 38: A non-transitory computer-readable medium storing code for wireless communication, the code comprising instructions executable by a processor to perform a method of any of aspects 1 through 18.

Aspect 39: A network entity for wireless communication, comprising one or more memories storing processor-executable code, and one or more processors coupled with the one or more memories and individually or collectively operable to execute the code to cause the network entity to perform a method of any of aspects 19 through 35.

Aspect 40: A network entity for wireless communication, comprising at least one means for performing a method of any of aspects 19 through 35.

Aspect 41: A non-transitory computer-readable medium storing code for wireless communication, the code comprising instructions executable by a processor to perform a method of any of aspects 19 through 35.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
communicate a signal using a first duplexing mode in accordance with a sub-band full-duplex capability of the UE;
perform one or more measurements on the signal to obtain a channel impulse response associated with communicating the signal; and
transmit a message comprising information indicative of an update pertaining to the sub-band full-duplex capability of the UE, wherein the update is based at least in part on the channel impulse response and identifies a second duplexing mode for wireless communication by the UE.

2. The UE of claim 1, wherein the one or more processors are individually or collectively further operable to execute the code to cause the UE to:
transmit a first message at a first time, the first message comprising first information that is indicative of the sub-band full-duplex capability of the UE and that identifies the first duplexing mode for wireless communication by the UE, wherein the message is transmitted at a second time subsequent to the first time, and wherein the update is relative to the first information.

3. The UE of claim 2, wherein:
the update includes that the sub-band full-duplex capability is maintained at the UE over a duration between the first time and the second time, and
the second duplexing mode is the same as the first duplexing mode based at least in part on the sub-band full-duplex capability being maintained.

4. The UE of claim 2, wherein:
the update includes that the sub-band full-duplex capability is not maintained at the UE over a duration between the first time and the second time, and
the second duplexing mode is different than the first duplexing mode based at least in part on the sub-band full-duplex capability not being maintained.

5. The UE of claim 4, wherein:
the message is transmitted to a network entity, and
the update indicates an expectation that the UE is operating in accordance with the second duplexing mode and the network entity is operating in accordance with the first duplexing mode.

6. The UE of claim 1, wherein:
the information is indicative of a modification to the sub-band full-duplex capability of the UE, and
the second duplexing mode is based at least in part on the modification.

7. The UE of claim 6, wherein the modification is associated with at least one of a spatial domain parameter, a power domain parameter, or a frequency domain parameter usable at the UE for wireless communications in accordance with one or more duplexing modes.

8. The UE of claim 6, wherein the modification is based at least in part on the channel impulse response satisfying a threshold.

9. The UE of claim 1, wherein the information comprises at least one bit corresponding to the update.

10. The UE of claim 9, wherein the one or more processors are individually or collectively further operable to execute the code to cause the UE to:
receive a second message comprising second information indicative of a mapping between the at least one bit and the update, wherein the information comprising the at least one bit is in accordance with the mapping.

11. The UE of claim 10, wherein:
the second information is indicative of a plurality of mappings between a plurality of bits and a plurality of updates, and
the plurality of mappings includes at least the mapping.

12. The UE of claim 1, wherein transmitting the message is based at least in part on an expiration of a timer.

13. The UE of claim 12, wherein the one or more processors are individually or collectively further operable to execute the code to cause the UE to:
transmit a first message comprising first information that is indicative of the sub-band full-duplex capability of the UE and that identifies the first duplexing mode for wireless communication by the UE; and
initiate the timer in response to transmitting the first message.

14. The UE of claim 12, wherein the one or more processors are individually or collectively further operable to execute the code to cause the UE to:
identify a modification to the sub-band full-duplex capability of the UE based at least in part on the channel impulse response; and
initiate the timer in response to identifying the modification, wherein transmitting the message is based at least in part on the modification being maintained at the UE over a duration of the timer.

15. The UE of claim 12, wherein the one or more processors are individually or collectively further operable to execute the code to cause the UE to:
receive an indication of a quantity of transmission time intervals (TTIs), wherein the timer is based at least in part on the quantity of TTIs.

16. The UE of claim 1, wherein the one or more processors are individually or collectively further operable to execute the code to cause the UE to:
receive an indication of a periodicity associated with reporting updates pertaining to the sub-band full-duplex capability of the UE, wherein transmitting the message is in accordance with the periodicity.

17. The UE of claim 1, wherein the information comprises an indication of the second duplexing mode.

18. A network entity, comprising:
one or more memories storing processor-executable code; and
one or more processors coupled with the one or more memories and individually or collectively operable to execute the code to cause the network entity to:
communicate a signal between the network entity and a user equipment (UE) in accordance with a first duplexing mode that is based at least in part on a sub-band full-duplex capability of the UE; and
obtain a message comprising information indicative of an update pertaining to the sub-band full-duplex capability of the UE, wherein the update is based at least in part on a channel impulse response associated with communicating the signal, and wherein the update identifies a second duplexing mode for wireless communication by the UE.

19. The network entity of claim 18, wherein the one or more processors are individually or collectively further operable to execute the code to cause the network entity to:
obtain a first message at a first time, the first message comprising first information that is indicative of the sub-band full-duplex capability of the UE and that identifies the first duplexing mode for wireless communication by the UE, wherein the message is obtained at a second time subsequent to the first time, and wherein the update is relative to the first information.

20. The network entity of claim 19, wherein:
the update includes that the sub-band full-duplex capability is maintained at the UE over a duration between the first time and the second time, and
the second duplexing mode is the same as the first duplexing mode based at least in part on the sub-band full-duplex capability being maintained.

21. The network entity of claim 19, wherein:
the update includes that the sub-band full-duplex capability is not maintained at the UE over a duration between the first time and the second time, and
the second duplexing mode is different than the first duplexing mode based at least in part on the sub-band full-duplex capability not being maintained.

22. The network entity of claim 21, wherein the update indicates an expectation that the UE is operating in accordance with the second duplexing mode and the network entity is operating in accordance with the first duplexing mode.

23. The network entity of claim 18, wherein:
the information is indicative of a modification to the sub-band full-duplex capability of the UE, and
the second duplexing mode is based at least in part on the modification.

24. The network entity of claim 23, wherein the modification is associated with at least one of a spatial domain parameter, a power domain parameter, or a frequency domain parameter usable at the UE for wireless communications in accordance with one or more duplexing modes.

25. The network entity of claim 23, wherein the modification is based at least in part on the channel impulse response satisfying a threshold.

26. The network entity of claim 18, wherein the information comprises at least one bit corresponding to the update.

27. The network entity of claim 18, wherein obtaining the message is based at least in part on an expiration of a timer.

28. The network entity of claim 18, wherein the one or more processors are individually or collectively further operable to execute the code to cause the network entity to:
output an indication of a periodicity associated with reporting updates pertaining to the sub-band full-duplex capability of the UE, wherein obtaining the message is in accordance with the periodicity.

29. A method for wireless communication by a user equipment (UE), comprising:
communicating a signal using a first duplexing mode in accordance with a sub-band full-duplex capability of the UE;
performing one or more measurements on the signal to obtain a channel impulse response associated with communicating the signal; and
transmitting a message comprising information indicative of an update pertaining to the sub-band full-duplex capability of the UE, wherein the update is based at least in part on the channel impulse response and identifies a second duplexing mode for wireless communication by the UE.

30. A method for wireless communication by a network entity, comprising:
communicating a signal between the network entity and a user equipment (UE) in accordance with a first duplexing mode that is based at least in part on a sub-band full-duplex capability of the UE; and
obtaining a message comprising information indicative of an update pertaining to the sub-band full-duplex capability of the UE, wherein the update is based at least in part on a channel impulse response associated with communicating the signal, and wherein the update identifies a second duplexing mode for wireless communication by the UE.
